(19) United States
(12) Patent Application Publication
(10) Pub. No.: US 2015/0050432 A1
(43) Pub. Date: Feb. 19, 2015

(54) POLYMERIZABLE COMPOSITION, POLYMERIZATION PRODUCT, ADHESIVE SHEET, METHOD FOR MANUFACTURING AN IMAGE DISPLAY DEVICE, AND IMAGE DISPLAY DEVICE

(71) Applicant: SHOWA DENKO K.K., Tokyo (JP)

(72) Inventors: Kazuhiko Ooga, Tokyo (JP); Hiroto Kouka, Tokyo (JP); Kai Suzuki, Tokyo (JP); Kenichi Nakanishi, Tokyo (JP)

(21) Appl. No.: 14/386,867

(22) PCT Filed: Feb. 26, 2013
(86) PCT No.: PCT/JP2013/054963

§ 371 Date: Sep. 22, 2014

(30) Foreign Application Priority Data
Mar. 28, 2012 (JP) 2012-074249

(51) Int. Cl. C08L 9/00; B32B 37/18; B32B 38/00; G09F 9/00

(52) U.S. Cl. CPC C08L 9/00; G09F 9/00; B32B 37/182; B32B 38/0008; B32B 2457/202
USPC 428/1.54; 428/336; 156/275.5; 156/60; 522/18; 522/64; 525/222; 525/223

(57) ABSTRACT

A polymerizable composition is disclosed wherein the polymerizable composition includes a first component selected from the group composed of compounds produced by an ester exchange reaction between a hydrogenated polyolefin polyol and an acrylic acid ester, compounds produced by an ester exchange reaction between a hydrogenated polyolefin polyol and a methacrylic acid ester, compounds produced by a dehydration condensation reaction between a hydrogenated polyolefin polyol and an acrylic acid, and compounds produced by a dehydration condensation reaction between a hydrogenated polyolefin polyol and a methacrylic acid, a second component selected from the group composed of compounds containing a hydrocarbon group with a carbon number more than or equal to 6 and an acryloyl group and compounds containing a hydrocarbon group with a carbon number more than or equal to 6 and a methacryloyl group, and a third component selected from the group composed of photopolymerization initiators.

### TECHNICAL FIELD

An aspect of the present invention relates to at least one of a polymerizable composition, a polymerization product, an adhesive sheet, a method for manufacturing an image display device, and an image display device.

### BACKGROUND ART

Conventionally, for example, a liquid crystal display device 101 illustrated in FIG. 6 has been known as such a kind of image display device.

As illustrated in FIG. 6, this liquid crystal display device 101 has a transparent protection part 103 composed of, for example, a glass or a plastic, on a liquid crystal display panel 102.

In this case, a spacer 104 is interposed between the liquid crystal display panel 102 and the protection part 103 to provide an air gap 105 between the liquid crystal display panel 102 and the protection part 103, because a surface of the liquid crystal display panel 102 and a (not-illustrated) light polarizing plate are protected.

However, light scattering is caused by the presence of the air gap 105 between the liquid crystal display panel 102 and the protection part 103 and causes degradation of contrast or brightness, and further, the presence of the air gap 105 prevents the panel from being made thinner.

While such a problem is taken into consideration, it has also been proposed (in, for example, Japanese Patent Application Publication No. 2005-055641 (Patent Document 1)) that an air gap between a liquid crystal display panel and a protection part is filled with a resin (see FIG. 1), however, deformation of an optical glass for narrowing a liquid crystal for a liquid crystal display panel is caused by stress due to curing shrinkage of a cured resin so that a defective display is caused by a disturbance in an orientation of a liquid crystal material or the like.

In order to solve the above-mentioned problem, for example, Japanese Patent Application Publication No. 2008-282000 (Patent Document 2) or Japanese Patent Application Publication No. 2009-186958 (Patent Document 3) discloses a curable composition with a low elastic modulus and a small factor of volume shrinkage at a time of curing thereof, wherein a polyurethane acrylate or an ester produced from a maleic anhydride adduct of a polyisoprene polymer and 2-hydroxyethyl methacrylate is used.

However, there is a problem that a factor of volume shrinkage of a curable composition using a polyurethane acrylate at a time of curing thereof is high (higher than 4.0%) or heat-caused discoloration of a cured product of a curable composition using an ester produced from a maleic anhydride adduct of a polyisoprene polymer and 2-hydroxyethyl methacrylate is high although a factor of volume shrinkage at a time of curing thereof is low.

Furthermore, smartphones are becoming mainstream among mobile phones in recent years and instruments called tablet PCs are also spreading rapidly. An electrostatic capacitance type touch panel is generally installed in such instruments. For a polymerization product (layer) filling between a display part and a touch panel of an add-on-type-electrostatic-capacitance-type-touch-panel-installing display device illustrated in FIG. 2 or FIG. 3 as one example of an electrostatic capacitance type touch panel (a polymerization product (layer) 5b depicted in FIG. 2 or FIG. 3) or a polymerization product (layer) filling between a display part and a touch-sensor-integrating-type protection part of a cover-glass-touch-sensor-integrating-type-electrostatic-capacitance-type-touch-panel-installing display device (a polymerization product (layer) 5b depicted in FIG. 4 or FIG. 5), a material with a low dielectric constant is desired from the viewpoint of prevention of malfunction and thinning thereof.

### PATENT DOCUMENTS

Patent Document 1: Japanese Patent Application Publication No. 2005-055641
Patent Document 2: Japanese Patent Application Publication No. 2008-282000
Patent Document 3: Japanese Patent Application Publication No. 2009-186958

### DISCLOSURE OF THE INVENTION

### Means for Solving the Problem

According to one aspect of the present invention, there is provided a polymerizable composition, including a first component selected from the group composed of compounds produced by an ester exchange reaction between a hydrogenated polyolefin polyol and an acrylic acid ester, compounds produced by an ester exchange reaction between a hydrogenated polyolefin polyol and a methacrylic acid ester, compounds produced by a dehydration condensation reaction between a hydrogenated polyolefin polyol and an acrylic acid, and compounds produced by a dehydration condensation reaction between a hydrogenated polyolefin polyol and a methacrylic acid, a second component selected from the group composed of compounds containing a hydrocarbon group with a carbon number more than or equal to 6 and an acryloyl group and compounds containing a hydrocarbon group with a carbon number more than or equal to 6 and a methacryloyl group, and a third component selected from the group composed of photopolymerization initiators.

According to another aspect of the present invention, there is provided a polymerization product obtainable by photopolymerizing the polymerizable composition as described above.

According to another aspect of the present invention, there is provided an adhesive sheet, including the polymerization product as described above and a layer having a thickness greater than or equal to 10 μm and less than or equal to 500 μm.

According to another aspect of the present invention, there is provided a method for manufacturing an image display device, including a step of interposing the polymerizable composition as described above between a base part having an image display part and a light-transmitting protection part, and a step of photopolymerizing the polymerizable composition to form a polymerization product layer between the base part and the protection part.

According to another aspect of the present invention, there is provided a method for manufacturing an image display device, including a step of bonding a base part having an image display part and a light-transmitting protection part by using the adhesive sheet as described above.

According to another aspect of the present invention, there is provided an image display device capable of being manufactured by the method for manufacturing an image display device as described above.

### BRIEF DESCRIPTION OF THE DRAWINGS

FIG. 1 is a cross-sectional diagram illustrating a main part of a display device according to an embodiment of the present invention.

FIG. 2 is a cross-sectional diagram illustrating a main part of a display device according to an embodiment of the present invention.

FIG. 3 is a cross-sectional diagram illustrating a main part of a display device according to an embodiment of the present invention.

FIG. 4 is a cross-sectional diagram illustrating a main part of a display device according to an embodiment of the present invention.

FIG. 5 is a cross-sectional diagram illustrating a main part of a display device according to an embodiment of the present invention.

FIG. 6 is a cross-sectional diagram illustrating a main part of a display device according to a conventional technique.

### MODE FOR CARRYING OUT THE INVENTION

Embodiments of the present invention will specifically be described below.

Here, a(n) “(meth)acryloyl group” in the present specification means an acryloyl group and/or a methacryloyl group.

Embodiment (I) of the present invention will be described.

Embodiment (I) of the present invention is a polymerizable composition for manufacturing a polymerization product that forms a polymerization product layer to be interposed between an image display part of an image display device and a light-transmitting protection part, wherein the polymerizable composition is characterized in that the polymerizable composition includes component 1 described below, component 2 described below, and component 3 described below as essential components.

Component 1: a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid;

Component 2: a compound that contains a hydrocarbon group with a carbon number more than or equal to 6 and a(n) (meth)acryloyl group;

Component 3: a photopolymerization initiator.

First, Component 1 will be described that is an essential component of a polymerizable composition in Embodiment (I) of the present invention.

Component 1 that is an essential component of a polymerizable composition in Embodiment (I) of the present invention is a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid.

A “hydrogenated polyolefin polyol” described herein is a polyol that is obtained by a hydrogenation reduction reaction of a polyolefin polyol. This hydrogenated polyolefin polyol has two or more hydroxyl groups in one molecule thereof, wherein it is preferable to have 2-4 hydroxyl groups. Furthermore, it is preferable for a hydroxyl group value of a hydrogenated polyolefin polyol to be 10-80 mgKOH/g, wherein 17-70 mgKOH/g is more preferable and 23-65 mgKOH/g is particularly preferable.

If a hydroxyl group value of a hydrogenated polyolefin polyol compound is less than 10 mgKOH/g, a molecular weight and a viscosity of an obtained (meth)acryl-group-containing polyolefin compound are too high and a handling property thereof is degraded so that handling thereof tends to be difficult. Furthermore, if a hydroxyl group value of a hydrogenated polyolefin polyol compound is greater than 80 mgKOH/g, a rate of volume shrinkage at a time of polymerization thereof is too large and a cohesive force of a polymer is too high, so that an adhesive property of a polymer is not sufficiently exerted, which is not necessarily preferable.

For a hydrogenated polyolefin structure of a hydrogenated polyolefin polyol, it is possible to provide a structure such as a hydrogenated polybutene, a hydrogenated polyisobutene, a hydrogenated polybutadiene, or a hydrogenated polyisoprene. It is preferable to contain a hydrogenated polyisoprene structure or a hydrogenated polybutadiene structure from the viewpoint of light resistance, heat-caused discoloration resistance, transparency (non-crystallinity), workability (liquid state) or the like, wherein it is more preferable to contain a hydrogenated poly-1,2-butadiene structure or a hydrogenated polyisoprene structure, and a structure is particularly preferable that has 50% by mass or more of a hydrogenated poly-1,2-butadiene structure or a hydrogenated polyisoprene structure in a total hydrogenated polyolefin structure, as a hydrogenated polyolefin structure in a hydrogenated polyolefin polyol.

It is sufficient for the number of (a(n)) (meth)acryloyl group(s) in a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid that is Component 1 in an embodiment of the present invention to be more than or equal to 1 in one molecule thereof, wherein 2-4 are more preferable.

For a representative example of Component 1 in an embodiment of the present invention, a structural formula of a(n) (meth)acrylate compound that is produced by an ester exchange reaction between a hydrogenated polybutadiene diol and an acrylic acid ester or a dehydration condensation reaction between a hydrogenated polybutadiene diol and an acrylic acid and a structural formula of a(n) (meth)acrylate compound that is produced by an ester exchange reaction between a hydrogenated polyisoprene diol and an acrylic acid ester or a dehydration condensation reaction between a hydrogenated polyisoprene diol and an acrylic acid are illustrated by Formulas (1) and (2), respectively.

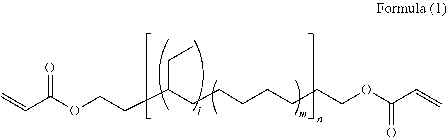

(In Formula (1), l, m, and n are integers greater than or equal to 1.)

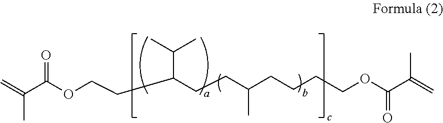

(In Formula (2), a, b, and c are integers greater than or equal to 1.)

In a case where a(n) (meth)acrylate compound as Component 1 is manufactured by an ester exchange reaction between a hydrogenated polyolefin polyol and a(n) (meth)acrylic acid ester, a(n) (meth)acrylate as Component 1 is generally manufactured by heating a hydrogenated polyolefin polyol and a lower alkyl ester of a(n) (meth)acrylic acid under the presence of an ester exchange catalyst to conduct an ester exchange reaction and distilling out a corresponding lower alkyl alcohol generated thereby, and for example, it is possible to manufacture a(n) (meth)acrylate compound as Component 1 by a method described in Japanese Patent Application Publication No. 2011-192853 or Japanese Patent Application Publication No. 2006-045284.

Furthermore, in a case where a(n) (meth)acrylate compound as Component 1 is manufactured by a dehydration condensation reaction between a hydrogenated polyolefin polyol and a(n) (meth)acrylic acid, a(n) (meth)acrylate as Component 1 is manufactured by heating a hydrogenated polyolefin polyol and a(n) (meth)acrylic acid under the presence of an esterification catalyst to conduct a dehydration reaction. However, when such a reaction is conducted by heating at a high temperature that is higher than or equal to 150° C., there is a risk for causing a radical polymerization of an acryloyl group during a dehydration condensation reaction. Therefore, it is common to conduct an esterification reaction under the presence of an azeotropic solvent for boiling water such as cyclohexane or toluene to cause azeotropic boiling of the aforementioned solvent and water and thereby remove water produced by a dehydration condensation reaction from a reactor. For a catalyst to be used for an esterification reaction, it is possible to provide an acidic catalyst such as p-toluenesulfonic acid.

For a method for manufacturing a(n) (meth)acrylate as Component 1, as described above, there are two methods, that is, a method for conducting an ester exchange reaction between a hydrogenated polyolefin polyol and a(n) (meth)acrylic acid ester and a method for conducting a dehydration condensation reaction between a hydrogenated polyolefin polyol and a(n) (meth)acrylic acid, wherein a method for manufacturing a(n) (meth)acrylate as Component 1 through an ester exchange reaction between a hydrogenated polyolefin polyol and a(n) (meth)acrylic acid ester is industrially preferable because it is unnecessary to use a solvent and a purification process is not conducted or it is possible to simplify a purification to be conducted.

It is preferable for an amount of Component 1 to be used in Embodiment (I) of the present invention to be 20-80% by mass relative to a total amount of a combination of Component 1 and Component 2 that are essential components for Embodiment (I) of the present invention, wherein 25-75% by mass is more preferable and 30-70% by mass is particularly preferable.

If an amount of Component 1 to be used in Embodiment (I) of the present invention is less than 20% by mass relative to a total amount of a combination of Component 1 and Component 2 that are essential components for Embodiment (I) of the present invention, a strength of a coating film of a polymerization product that is obtained by polymerizing a polymerizable composition in Embodiment (I) of the present invention may be degraded or a dielectric constant of a polymerization product that is obtained by polymerizing such a polymerizable composition may be high, which is not necessarily preferable. Furthermore, if an amount of Component 1 to be used in Embodiment (I) of the present invention is greater than 80% by mass relative to a total amount of a combination of Component 1 and Component 2 that are essential components for Embodiment (I) of the present invention, a viscosity of a polymerizable composition in Embodiment (I) of the present invention may be high, which is not preferable.

Next, Component 2 will be described that is an essential component of a polymerizable composition in Embodiment (I) of the present invention.

Component 2 that is an essential component of a polymerizable composition in Embodiment (I) of the present invention is a compound that contains a hydrocarbon group with a carbon number more than or equal to 6 and a(n) (meth)acryloyl group.

For a compound that contains a hydrocarbon group with a carbon number more than or equal to 6 and a(n) (meth)acryloyl group, it is possible to provide, for example, a(n) (meth) acryloyl-group-containing compound that has a cyclic aliphatic group, such as cyclohexyl acrylate, isobornyl acrylate, dicyclopentenyl acrylate, dicyclopentenyloxyethyl acrylate, dicyclopentanyl acrylate, dicyclopentanyloxyethyl acrylate, 4-tert-butylcyclohexyl acrylate, isobornyl methacrylate, dicyclopentenyl methacrylate, dicyclopentenyloxyethyl methacrylate, dicyclopentanyl methacrylate, dicyclopentanyloxyethyl methacrylate, or 4-tert-butylcyclohexyl methacrylate, a(n) (meth)acryloyl-group-containing compound that has a straight-chain aliphatic group, such as hexyl acrylate, lauryl acrylate, isononyl acrylate, 2-propylheptyl acrylate, 4-methyl-2-propylhexyl acrylate, isooctadecyl acrylate, 2-heptylundecyl acrylate, lauryl methacrylate, isononyl methacrylate, 2-propylheptyl methacrylate, 4-methyl-2-propylhexyl methacrylate, isooctadecyl methacrylate, or 2-heptylundecyl methacrylate, or the like.

Among these, a(n) (meth)acryloyl-group-containing compound that has a hydrocarbon group with a carbon number more than or equal to 9, such as isobornyl acrylate, dicyclopentenyl acrylate, dicyclopentenyloxyethyl acrylate, dicyclopentanyl acrylate, dicyclopentanyloxyethyl acrylate, 4-tert-butylcyclohexyl acrylate, isobornyl methacrylate, dicyclopentenyl methacrylate, dicyclopentenyloxyethyl methacrylate, dicyclopentanyl methacrylate, dicyclopentanyloxyethyl methacrylate, 4-tert-butylcyclohexyl methacrylate, lauryl acrylate, isononyl acrylate, 2-propylheptyl acrylate, 4-methyl-2-propylhexyl acrylate, isooctadecyl acrylate, 2-heptylundecyl acrylate, lauryl methacrylate, isononyl methacrylate, 2-proprylheptyl methacrylate, 4-methyl-2-propylhexyl methacrylate, isooctadecyl methacrylate, or 2-heptylundecyl methacrylate, is preferable in order to keep a low dielectric constant of a polymerization product in an embodiment of the present invention or an adhesive sheet for optics in an embodiment of the present invention, as described below, wherein isobornyl acrylate, dicyclopentanyl acrylate, dicyclopentanyloxyethyl acrylate, isobornyl methacrylate, dicyclopentanyl methacrylate, dicyclopentanyloxyethyl methacrylate, lauryl acrylate, isononyl acrylate, 2-propylheptyl acrylate, 4-methyl-2-propylhexyl acrylate, isostearyl acrylate, lauryl methacrylate, isononyl methacrylate, 2-propylheptyl methacrylate, 4-methyl-2-propylhexyl methacrylate, or isostearyl methacrylate, is preferable when heat-caused discoloration resistance is further taken into consideration, wherein lauryl acrylate, isononyl acrylate, 2-propylheptyl acrylate, 4-methyl-2-propylhexyl acrylate, isooctadecyl acrylate, 2-heptylundecyl acrylate, isononyl methacrylate, 2-propylheptyl methacrylate, 4-methyl-2-propylhexyl methacrylate, isooctadecyl methacrylate, or 2-heptylundecyl methacrylate, is more preferable when a dilution efficiency of Component 4 as described below is taken into consideration, lauryl acrylate, isononyl acrylate, 2-propylheptyl acrylate, 4-methyl-2-propylhexyl acrylate, or 2-heptylundecyl acrylate, is particularly preferable wherein when a photopolymerization rate is taken into consideration.

It is preferable for an amount of Component 2 to be used in Embodiment (I) of the present invention to be 20-80% by mass relative to a total amount of a combination of Component 1 and Component 2 that are essential components for Embodiment (I) of the present invention, wherein 25-75% by mass is more preferable and 30-70% by mass is particularly preferable. If an amount of Component 2 to be used in Embodiment (I) of the present invention is less than 20% by mass relative to a total amount of a combination of Component 1 and Component 2 that are essential components for Embodiment (I) of the present invention, a viscosity of a polymerizable composition in Embodiment (I) of the present invention may be too high, which is not preferable. Furthermore, if an amount of Component 2 to be used in Embodiment (I) of the present invention is greater than 80% by mass relative to a total amount of a combination of Component 1 and Component 2 that are essential components for Embodiment (I) of the present invention, it is possible for a rate of volume shrinkage at a time of polymerization of a polymerizable composition in Embodiment (I) of the present invention to be high or it is possible for a dielectric constant of a cured product to be high, which is not preferable.

Next, Component 3 will be described that is an essential component of a polymerizable composition in Embodiment (I) of the present invention.

Component 3 that is an essential component of a polymerizable composition in Embodiment (I) of the present invention is a photopolymerization initiator.

A photopolymerization initiator as Component 3 is not particularly limited as long as the photopolymerization initiator is a compound that generates a radical contributing to initiation of a radical polymerization, due to irradiation with light such as a near-infrared ray, a visible light ray, or an ultraviolet ray.

For a photopolymerization initiator as Component 3, it is possible to provide, specifically, acetophenone, 2,2-dimethoxy-2-phenylacetophenone, diethoxyacetophenone, 1-hydroxycyclohexyl phenyl ketone, 1-hydroxy-2-methyl-1-phenylpropene-1-one, α-hydroxycyclohexyl phenyl ketone, 2-hydroxy-2-methyl-1-phenylpropane-1-one, 2-hydroxy-2-methyl-1-(4-isopropylphenyl)propane-1-one, 2-hydroxy-2-methyl-1-(4-dodecylphenyl)propane-1-one, 2-hydroxy-2-methyl-1-[(2-hydroxyethoxy)phenyl]propanone, benzophenone, 2-methylbenzophenone, 3-methylbenzophenone, 4-methylbenzophenone, 4-methoxybenzophenone, 2-chlorobenzophenone, 4-chlorobenzophenone, 4-bromobenzophenone, 2-carboxybenzophenone, 2-ethoxycarbonylbenzopheneone, 4-benzoyl-4′-methyldiphenyl sulfide, benzophenonetetracarboxylic acid or its tetramethyl ester, a 4,4′-bis(dialkylamino)benzophenone (for example, 4,4′-bis(dimethylamino)benzophenone, 4,4′-bis(dicyclohexylamino)benzophenone, 4,4′-bis(diethylamino)benzophenone, or 4,4′-bis(dihydroxyethylamino)benzophenone), 4-methoxy-4′-dimethylaminobenzophenone, 4,4′-dimethoxybenzophenone, 4-dimethylaminobenzophenone, 4-dimethylaminoacetophenone, benzil, anthraquinone, 2-t-butylanthraquinone, 2-methylanthraquinone, phenanthraquinone, fluorenone, 2-benzyl-2-dimethylamino-1-(4-morpholinophenyl)-1-butanone, 2-(dimethylamino)-2-[(4-methylphenyl)methyl]-1-[4-(4-morpholinyl)phenyl]-1-butanone, 2-methyl-1-[4-(methylthio)phenyl]-2-morpholino-1-propanone, a 2-hydroxy-2-methyl-[4-(1-methylvinyl)phenyl]propanol oligomer, benzoin, a benzoin ether (for example, benzoin methyl ether, benzoin ethyl ether, benzoin propyl ether, benzoin isopropyl ether, benzoin isobutyl ether, benzoin phenyl ether, or benzyl dimethyl ketal), acridone, chloroacridone, N-methylacridone, N-butylacridone, N-butyl-chloroacridone, 2,4,6-trimethylbenzoyl-diphenylphosphine oxide, 2,6-dimethoxybenzoyl-diphenylphosphone oxide, 2,6-dichlorobenzoyl-diphenylphosphine oxide, 2,4,6-trimethylbenzoyl-methoxy-phenylphosphoine oxide, 2,4,6-trimethylbenzoyl-ethoxy-phenylphosphine oxide, 2,3,5,6-tetramethylbenzoyl-diphenylphosphine oxide, benzoyl di-(2,6-dimethylphenyl) phosphonate, or the like. For a bisacylphosphine oxide, it is possible to provide bis-(2,6-dichlorobenzoyl)phenylphosphine oxide, bis-(2,6-dichlorobenzoyl)-2,5-dimethylphenylphosphine oxide, bis-(2,6-dichlorobenzoyl)-4-propylphenylphosphine oxide, bis-(2,6-dichlorobenzoyl)-1-naphthylphosphine oxide, bis-(2,6-dimethoxybenzoyl)phenylphosphine oxide, bis-(2,6-dimethoxybenzoyl)-2,4,4-trimethylpentylphosphine oxide, bis-(2,6-dimethoxybenzoyl)-2,5-dimethylphenylphosphine oxide, bis-(2,4,6-trimethylbenzoyl)phenylphosphine oxide, (2,5,6-trimethylbenzoyl)-2,4,4-trimethylpentylphosphine oxide, 2-isopropylthioxanthone, 4-isopropylthioxanthone, 2,4-diethylthioxanthone, 2,4-dichlorothioxanthone, 1-chloro-4-propoxythioxanthone, or the like.

Furthermore, it is also possible to use a metallocene compound as a photopolymerization initiator. For a metallocene compound, it is possible to use a transition element represented by Fe, Ti, V, Cr, Mn, Co, Ni, Mo, Ru, Rh, Lu, Ta, W, Os, Ir, or the like as a central metal, and it is possible to provide, for example, bis(η5-2,4-cyclopentadiene-1-yl)-bis[2,6-difluoro-3-(pyrrole-1-yl)phenyl]titanium.

It is possible to use each of these photopolymerization initiators separately or two or more kinds thereof in combination.

Among these, 2-hydroxy-2-methyl-1-phenylpropane-1-one, 1-hydroxycyclohexyl phenyl ketone, 2,4,6-trimethylbenzoyl-diphenylphosphine oxide, 2,4,6-trimethylbenzoyl-ethoxy-phenylphosphine oxide, or 2,3,5,6-tetramethylbenzoyl-diphenylphosphine oxide is preferable, wherein 1-hydroxycyclohexyl phenyl ketone, 2,4,6-trimethylbenzoyl-diphenylphosphine oxide, or 2,4,6-trimethylbenzoyl-ethoxy-phenylphosphine oxide is particularly preferable, wherein separate use of 2,4,6-trimethylbenzoyl-diphenylphosphine oxide, separate use of 2,4,6-trimethylbenzoyl-ethoxy-phenylphosphine oxide, combinational use of 1-hydroxycyclohexyl phenyl ketone and 2,4,6-trimethylbenzoyl-diphenylphosphine oxide, combinational use of 1-hydroxycyclohexyl phenyl ketone and 2,4,6-trimethylbenzoyl-ethoxy-phenylphosphine oxide, combinational use of 2,4,6-trimethylbenzoyl-diphenylphosphine oxide and 2,4,6-trimethylbenzoyl-ethoxy-phenylphosphine oxide, or combinational use of three kinds that are 1-hydroxycyclohexyl phenyl ketone, 2,4,6-trimethylbenzoyl-diphenylphosphine oxide, and 2,4,6-trimethylbenzoyl-ethoxy-phenylphosphine oxide, is most preferable.

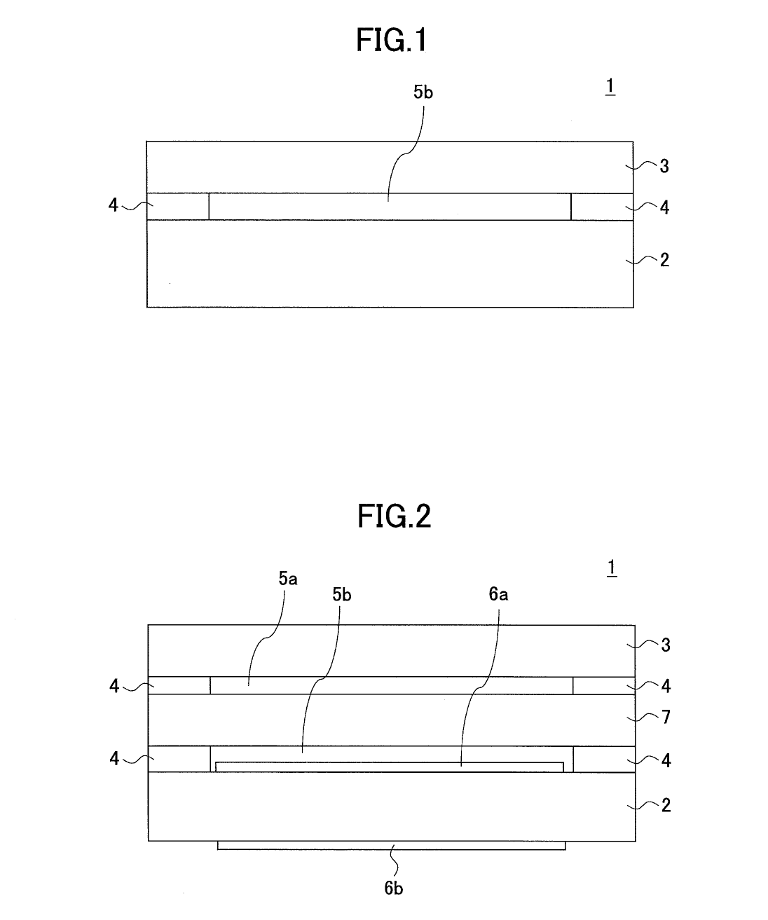

Furthermore, a protection part 3 in FIG. 1-FIG. 5 may be provided with a function of cutting an ultraviolet ray region from the viewpoint of protection of a display part 2 from an ultraviolet ray. In that case, it is preferable to use 2,4,6-trimethylbenzoyl-diphenylphosphine oxide, 2,3,5,6-tetramethylbenzoyl-diphenylphosphine oxide, or 2,4,6-trimethylbenzoyl-ethoxy-phenylphosphine oxide that is a photopolymerization initiator capable of sensing light even in a visible light region, wherein 2,4,6-trimethylbenzoyl-ethoxy-phenylphosphine oxide or 2,4,6-trimethylbenzoyl-diphenylphosphine oxide is particularly preferable.

It is preferable for an amount of Component 3 to be used in Embodiment (I) of the present invention to be 0.05-10.0 parts by mass relative to a total amount or 100 parts by mass of a combination of Component 1 and Component 2 that are essential components for Embodiment (I) of the present invention, wherein 0.1-7.0 parts by mass is more preferable and 0.2-5.0 parts by mass is particularly preferable. If an amount of Component 3 to be used is less than 0.05 parts by mass relative to a total amount or 100 parts by mass of a combination of Component 1 and Component 2 that are essential components for Embodiment (I) of the present invention, a polymerization initiation performance of a polymerization initiator may be insufficient, which is not preferable. Furthermore, if an amount of Component 3 to be used in Embodiment (I) of the present invention is greater than 10.0 parts by mass relative to a total amount or 100 parts by mass of a combination of Component 1 and Component 2 that are essential components for Embodiment (I) of the present invention, a polymerization product in Embodiment (III) of the present invention or Embodiment (IV) of the present invention as described below or an adhesive sheet for optics in Embodiment (VI) of the present invention or Embodiment (VII) of the present invention as described below may readily be colored in a case where it is provided under a high temperature environment, which is not necessarily preferable.

Next, Embodiment (II) of the present invention will be described.

Embodiment (II) of the present invention is a polymerizable composition for manufacturing a polymerization product that forms a polymerization product layer to be interposed between an image display part of an image display device and a light-transmitting protection part, wherein the polymerizable composition is characterized in that the polymerizable composition includes Component 1 described below, Component 2 described below, Component 3 described below, and Component 4 described below, as essential components.

Component 1: a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid;

Component 2: a compound that contains a hydrocarbon group with a carbon number more than or equal to 6 and a(n) (meth)acryloyl group;

Component 3: a photopolymerization initiator; and

Component 4: a compound with no (meth)acryloyl group in a molecule thereof that does not have any one of a function of suppressing a radical polymerization, a function of inhibiting a radical polymerization, and a photopolymerization initiation function and is composed of a carbon atom(s) and a hydrogen atom(s) or composed of a carbon atom(s), a hydrogen atom(s), and an oxygen atom(s).

Component 1 that is an essential component of a polymerizable composition in Embodiment (II) of the present invention is a(n) (meth)acrylate compound similar to Component 1 that is an essential component of Embodiment (I) of the present invention as described above.

It is preferable for an amount of Component 1 to be used in Embodiment (II) of the present invention to be 7-70% by mass relative to a total amount of a combination of Component 1, Component 2, and Component 4 that are essential components for Embodiment (II) of the present invention, wherein 10-65% by mass is more preferable and 12-60% by mass is particularly preferable.

If an amount of Component 1 to be used in Embodiment (II) of the present invention is less than 7% by mass relative to a total amount of a combination of Component 1, Component 2, and Component 4 described below that are essential components for Embodiment (II) of the present invention, a strength of a coating film of a polymerization product that is obtained by polymerizing a polymerizable composition in Embodiment (II) of the present invention may be degraded or a dielectric constant of a polymerization product that is obtained by polymerizing such a polymerizable composition may be high, which is not necessarily preferable. Furthermore, if an amount of Component 1 to be used in Embodiment (II) of the present invention is greater than 70% by mass relative to a total amount of a combination of Component 1, Component 2, and Component 4 that are essential components for Embodiment (II) of the present invention, a viscosity of a polymerizable composition in Embodiment (II) of the present invention may be high, which is not preferable.

Component 2 that is an essential component of a polymerizable composition in Embodiment (II) of the present invention is a(n) (meth)acryloyl-group-containing compound similar to Component 2 that is an essential component of Embodiment (I) of the present invention as described above.

It is preferable for an amount of Component 2 to be used in Embodiment (II) of the present invention to be 7-70% by mass relative to a total amount of a combination of Component 1, Component 2, and Component 4 described below that are essential components for Embodiment (II) of the present invention, wherein 10-65% by mass is more preferable and 12-60% by mass is particularly preferable. If an amount of Component 2 to be used in Embodiment (II) of the present invention is less than 7% by mass relative to a total amount of a combination of Component 1, Component 2, and Component 4 that are essential components for Embodiment (II) of the present invention, a viscosity of a polymerizable composition in Embodiment (II) of the present invention may be too high, which is not preferable. Furthermore, if an amount of Component 2 to be used in Embodiment (II) of the present invention is greater than 70% by mass relative to a total amount of a combination of Component 1, Component 2, and Component 4 that are essential components for Embodiment (II) of the present invention, it is possible for a rate of volume shrinkage at a time of polymerization of a polymerizable composition in Embodiment (II) of the present invention to be high or it is possible for a dielectric constant of a cured product to be high, which is not preferable.

Component 3 that is an essential component of a polymerizable composition in Embodiment (II) of the present invention is a photopolymerization initiator similar to Component 3 that is an essential component of Embodiment (I) of the present invention as described above.

It is preferable for an amount of Component 3 to be used in Embodiment (II) of the present invention to be 0.05-10.0 parts by mass relative to a total amount or 100 parts by mass of a combination of Component 1, Component 2, and Component 4 described below that are essential components for Embodiment (II) of the present invention, wherein 0.1-7.0 parts by mass is more preferable and 0.2-5.0 parts by mass is particularly preferable. If an amount of Component 3 to be used in Embodiment (II) of the present invention is less than 0.05 parts by mass relative to a total amount or 100 parts by mass of a combination of Component 1, Component 2, and Component 4 that are essential components for Embodiment (II) of the present invention, a polymerization initiation performance of a polymerization initiator may be insufficient, which is not preferable. Furthermore, if an amount of Component 3 to be used in Embodiment (II) of the present invention is greater than 10.0 parts by mass relative to a total amount or 100 parts by mass of a combination of Component 1, Component 2, and Component 4 that are essential components for Embodiment (II) of the present invention, a polymerization product in Embodiment (III) of the present invention as described below or an adhesive sheet for optics in Embodiment (V) of the present invention as described below may readily be colored in a case where such an adhesive sheet for optics is provided under a high temperature environment, which is not necessarily preferable.

Next, Component 4 will be described that is an essential component of a polymerizable composition in Embodiment (II) of the present invention.

Component 4 that is an essential component of a polymerizable composition in Embodiment (II) of the present invention is a compound with no (meth)acryloyl group in a molecule thereof that does not have any one of a function of suppressing a radical polymerization, a function of inhibiting a radical polymerization, and a photopolymerization initiation function and is composed of a carbon atom(s) and a hydrogen atom(s) or composed of a carbon atom(s), a hydrogen atom(s), and an oxygen atom(s), and is not particularly limited as long as Component 4 is a compound that does not impair a uniformity of a polymerizable composition in Embodiment (II) of the present invention that is provided with Component 1-Component 4 as essential components, at 30° C.

In regard to Component 4, in particular, in a case where an image display device is manufactured by using a manufacturing method that has a process for interposing and polymerizing a polymerizable composition between a base part that has an image display part and a light-transmitting protection part to form a polymerization product layer, it is necessary to include Component 4 in a polymerizable composition to be used in this process, for a purpose of keeping a low rate of volume shrinkage at a time of polymerization thereof. Furthermore, Component 4 may be used for a purpose of increasing an adhesive property of a polymerization product to a glass or acrylic resin object or the like other than keeping a rate of volume shrinkage at a time of polymerization.

It is possible to use a compound that is liquid at 25° C. or a compound that is solid at 25° C., as Component 4.

For a compound that is used as Component 4 and is a liquid at 25° C., it is possible to provide, for example, a poly(α-olefin) liquid substance, an ethylene-propylene copolymerization liquid substance, a propylene-α-olefin copolymerization liquid substance, an ethylene-α-olefin copolymerization liquid substance, a liquid polybutene, a liquid hydrogenated polybutene, a liquid polybutadiene, a liquid hydrogenated polybutadiene, a liquid polyisoprene, a liquid hydrogenated polyisoprene, a liquid polybutadiene polyol, a liquid hydrogenated polybutadiene polyol, a liquid polyisoprene polyol, a liquid hydrogenated polyisoprene polyol, a hydrogenated dimer diol, or the like.

A poly(α-olefin) liquid substance is a liquid substance manufactured by polymerization of an α-olefin, wherein such an α-olefin is a hydrocarbon compound that has 1 carbon-carbon double bond at a terminal of a molecule thereof and it is possible to provide, for example, 1-butene, 1-pentene, 1-hexene, 1-octene, 1-decene, 1-dodecene, 1-tetradecene, 1-hexadecene, 1-octadecene, or the like.

An ethylene-α-olefin copolymerization liquid substance is a liquid polymer manufactured by copolymerizing ethylene and an α-olefin. An α-olefin is a hydrocarbon compound that has 1 carbon-carbon double bond at a terminal of a molecule thereof and it is possible to provide, for example, 1-butene, 1-pentene, 1-hexene, 1-octene, 1-decene, 1-dodecene, 1-tetradecene, 1-hexadecene, 1-octadecene, or the like.

A propylene-α-olefin copolymerization liquid substance is a liquid polymer manufactured by copolymerizing propylene and an α-olefin. An α-olefin is a hydrocarbon compound that has 1 carbon-carbon double bond at a terminal of a molecule thereof and it is possible to provide, for example, 1-butene, 1-pentene, 1-hexene, 1-octene, 1-decene, 1-dodecene, 1-tetradecene, 1-hexadecene, 1-octadecene, or the like.

A liquid polybutene is a liquid polymer that includes isobutene or n-butene as a (co)polymerization component(s), such as homopolymerization of isobutene, homopolymerization of n-butene, or copolymerization of isobutene and n-butene, and a compound that has a carbon-carbon unsaturated bond at one of the terminals thereof. For a commercial item of a liquid polybutene, it is possible to provide, for example, Nisseki Polybutene LV-7, LV-50, LV-100, HV-15, HV-35, HV-50, NV-100, or HV-300, produced by JX NIPPON OIL & ENERGY CORPORATION, or the like.

A liquid hydrogenated polybutene is a liquid substance that has a side chain obtained by hydrogenating the liquid polybutene described above, and it is possible to provide, for example, PERLEAM 4, PERLEAM 6, PERLEAM 18, PERLEAM 24, or PERLEAM EX, produced by NOF CORPORATION, or the like.

A liquid polybutadiene is a butadiene polymer that is liquid at an ordinary temperature, and it is possible to provide, for example, POLYVEST 110 or POLYVEST 130 produced by EVONIK DEGUSSA JAPAN CO., LTD., NISSO-PB B-1000, NISSO-PB B-2000, or NISSO-PB B-3000 produced by NIPPON SODA CO., LTD. or the like.

A liquid hydrogenated polybutadiene is a substance that is liquid at an ordinary temperature and is obtained by reducing or hydrogenating a butadiene polymer, and it is possible to provide, for example, NISSO-PB BI-2000 or NISSO-PB BI-3000 produced by NIPPON SODA CO., LTD., or the like.

A liquid polyisoprene is an isoprene polymer that is liquid at an ordinary temperature, and it is possible to provide, for example, Kuraprene LIR-30 produced by KURARAY CO. LTD. or the like.

A liquid hydrogenated polyisoprene is a compound that is obtained by reducing or hydrogenating an isoprene polymer and is a liquid at an ordinary temperature, and it is possible to provide LIR-200 produced by KURARAY CO. LTD. or the like.

A liquid polybutadiene polyol is a polymer that is liquid at an ordinary temperature and has 2 or more hydroxyl groups at a terminal(s) of a molecule thereof and a polybutadiene structural unit, and it is possible to provide, for example, NISSO-PB G-1000, NISSO-PB G-2000, or NISSO-PB G-3000 produced by NIPPON SODA CO., LTD., Poly bd produced by IDEMITSU KOSAN CO., LTD., or the like.

A liquid hydrogenated polybutadiene polyol is a liquid polyol that has a structure obtained by reducing or hydrogenating polybutadiene polyol or polybutadiene polycarboxylic acid, and it is possible to provide, NISSO-PB GI-1000, NISSO-PB GI-2000, or NISSO-PB GI-3000, produced by NIPPON SODA CO., LTD., or the like.

A liquid polyisoprene polyol is a polymer that is liquid at an ordinary temperature and has 2 or more hydroxyl groups at a terminal(s) of a molecule thereof and a polyisoprene structural unit, and it is possible to provide, for example, Poly ip produced by IDEMITSU KOSAN CO., LTD., or the like.

A liquid hydrogenated polyisoprene polyol is a liquid polyol that has a structure obtained by reducing or hydrogenating polyisoprene polyol or polyisoprene polycarboxylic acid, and it is possible to provide, for example, EPOL produced by IDEMITSU KOSAN CO., LTD., or the like.

A hydrogenated dimer diol is a polyol obtained by reducing or hydrogenating a dimer acid.

A dimer acid refers to a dimeric acid that has a six-membered ring (cyclohexene ring) obtained by reacting between a fatty acid with a carbon number of 14-22 that has 2-4 ethylenic double bonds (that will be referred to as an “unsaturated fatty acid A” below), preferably a fatty acid with a carbon number of 14-22 that has 2 ethylenic double bonds, and a fatty acid with a carbon number of 14-22 that has 1-4 ethylenic double bonds (that will be referred to as an “unsaturated fatty acid B” below), preferably a fatty acid with a carbon number of 14-22 that has 1 or 2 ethylenic double bonds, at double bond moieties thereof. For an unsaturated fatty acid A as described above, it is possible to provide a tetradecadienoic acid, a hexadecadienoic acid, an octadecadienoic acid (such as linoleic acid), an eicosadienoic acid, a docosadienoic acid, an octadecatrienoic acid (such as linolenic acid), an eicosatetraenoic acid (such as arachidonic acid), or the like, wherein linoleic acid is most preferable. Furthermore, for an unsaturated fatty acid B, it is possible to provide, a tetradecenoic acid (tsuzuic acid, sperm acid, or myristoleic acid), a hexadecenoic acid (such as palmitoleic acid), an octadecenoic acid (such as oleic acid, elaidic acid, or vaccenic acid), an eicosenoic acid (such as gadoleic acid), a docosenoic acid (such as erucic acid, cetoleic acid, or brassidic acid), or the like, as a fatty acid with a carbon number of 14-22 that has 1 ethylenic double bond, in addition to the illustrations described above, wherein oleic acid or linoleic acid is most preferable.

For a ratio (molar ratio) of an unsaturated fatty acid A to an unsaturated fatty acid B to be used in a dimerization reaction described above, about 1:1.2-1.2:1 is preferable and 1:1 is most preferable. It is possible to cause a dimerization reaction described above in accordance with a publicly-known method, for example, a method described in Japanese Patent Application Publication No. 9-136861. That is, it is possible to cause a dimerization reaction described above by, for example, adding a Lewis acid or Bronsted acid type liquid or solid catalyst, preferably a montmorillonite type activated white earth, to an unsaturated fatty acid A and an unsaturated fatty acid B in such a manner that 1-20% by weight, preferably 2-8% by weight, thereof is provided relative to A+B, and conducting heating thereof at 200-270° C., preferably, 220-250° C. A pressure at a time of such a reaction is usually of a slightly pressurized state and may be an ordinary pressure. A reaction time period is changed depending on an amount of a catalyst and/or a reaction temperature, and usually 5-7 hours. After completion of such a reaction, a catalyst is filtered out, then distillation under a reduced pressure is conducted to distill away an unreacted raw material or an isomerized fatty acid, and subsequently a dimer acid fraction is distilled, so that it is possible to obtain such a dimer acid. Although it is considered that a dimerization reaction described above proceeds through a transfer of a double bond (isomerization) and a Diels-Alder reaction, an embodiment of the present invention is not bound thereby.

An obtained dimer acid is usually a mixture of dimer acids with a position of a 6-membered ring being different depending on a bonding site of a double bond or an isomerization, wherein such dimer acids may be separated to be used and it is possible to use such a dimer acid mixture directly. Moreover, an obtained dimer acid may contain a minor amount of a monomer acid (for example, less than or equal to 3% by weight, in particular, less than or equal to 1% by weight), a polymer acid (for example, less than or equal to 3% by weight, in particular, less than or equal to 1% by weight) that is a trimer or more-monomer acid, or the like.

A main component of a hydrogenated dimer diol is a diol provided in such a manner that at least one kind of a dimer acid, a hydrogenated dimer acid obtained by hydrogenating a carbon-carbon unsaturated bond of a dimer acid, or a lower alcohol ester thereof is reduced under presence of a catalyst to convert a carboxylic acid or carboxylate moiety of a dimer acid into an alcohol, and in a case where a raw material has a carbon-carbon double bond, such a double bond is hydrogenated.

A structure of a main component of a hydrogenated dimer diol is a structure represented by any of Formula (3) and Formula (4) described below.

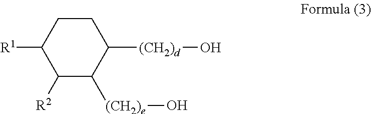

(In formula (3), any of R¹ and R² is an alkyl group and a total of respective contained-carbon numbers of R¹ and R², d, and e is 30 (that is, a contained-carbon number of R¹+a contained-carbon number of R²+d+e=30).)

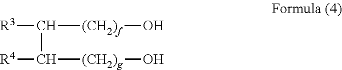

(In Formula (4), any of R³ and R⁴ is an alkyl group and a total of respective contained-carbon numbers of R³ and R³, f, and g is 34 (that is, a contained-carbon number of R³+a contained-carbon number of R⁴+f+g=34).

For a commercial item of a hydrogenated dimer diol, it is possible to provide, for example, PRIPOL (registered trademark) 2033 or the like (produced by Croda International PIC.) or Sovermol (registered trademark) 908 (produced by COGNIS JAPAN CO. LTD.).

In a case where heat resistance is taken into consideration, it is preferable to be a compound that has 1 or less carbon-carbon unsaturated bond in a molecule thereof, wherein a liquid poly(α-olefin) liquid substance, an ethylene-propylene copolymerization liquid substance, an ethylene-α-olefin copolymerization liquid substance, a propylene-α-olefin copolymerization liquid substance, a liquid polybutene, a liquid hydrogenated polybutene, a liquid hydrogenated polybutadiene, a liquid hydrogenated polyisoprene, a liquid hydrogenated polybutadiene polyol, a liquid hydrogenated polyisoprene polyol, or a hydrogenated dimer diol is more preferable. Furthermore, combinational use of at least one kind selected from a liquid poly(α-olefin) liquid substance, an ethylene-α-olefin copolymerization liquid substance, a liquid polybutene, a liquid hydrogenated polybutene, a liquid hydrogenated polybutadiene, and a liquid hydrogenated polyisoprene, and at least one kind selected from a liquid hydrogenated polybutadiene polyol and a liquid hydrogenated polyisoprene polyol is particularly preferable.

Furthermore, in Embodiment (II) of the present invention, it is also possible to use a compound that is solid at 25° C., as Component 4.

For a compound that is solid at 25° C. and is used as Component 4, it is possible to be a compound that does not have a carbon-carbon unsaturated bond in a molecule thereof.

For such a compound, it is possible to provide an epoxy resin that is solid at 25° C., a polyester resin that is solid at 25° C., a polyol resin that is solid at 25° C., a hydrogenated petroleum resin, a terpene-type hydrogenated resin, a hydrogenated rosin ester, or the like.

Among these, as a preferable one, it is possible to provide a hydrogenated petroleum resin, a terpene-type hydrogenated resin, or a hydrogenated rosin ester.

A hydrogenated petroleum resin is a resin obtained by reducing or hydrogenating a petroleum-type resin. For a petroleum-type resin that is a raw material for a hydrogenated petroleum resin, it is possible to provide an aliphatic petroleum resin, an aromatic petroleum resin, an aliphatic-aromatic copolymerization-type petroleum resin, an alicyclic petroleum resin, a dicyclopentadiene resin, or a modified substance of such a hydrogenated substance. A synthetic petroleum resin may be either a C5-type or a C9-type.

A terpene-type hydrogenated resin is a resin obtained by reducing or hydrogenating a terpene-type resin. For a terpene-type resin that is a raw material for a terprene-type hydrogenated resin, it is possible to provide a β-pinene resin, an α-pinene resin, a β-limonene resin, an α-limonene resin, a pinene-limonene copolymerization resin, a pinene-limonene-styrene copolymerization resin, a terpene-phenol resin, an aromatic modified terpene resin, or the like. Many of these terprene-type resins are resins that do not have a polar group.

A hydrogenated rosin ester is a resin obtained by esterifying a hydrogenated rosin obtained by hydrogenating a rosin-type resin or hydrogenating or reducing a rosin ester obtained by esterifying a rosin. For a rosin-type resin tackifier, it is possible to provide a modified rosin such as a gum rosin, a tall oil rosin, a wood rosin, a disproportionated rosin, a polymerized rosin, or a maleic rosin, or the like.

Among these, a terpene-type hydrogenated resin is more preferable, and a resin obtained by reducing or hydrogenating a polypinene, a polylimonene, or a pinene-limonene copolymerization resin or a resin obtained by reducing or hydrogenating a carbon-carbon unsaturated bond of a pinene-styrene copolymerization resin, a limonene-styrene copolymerization resin, or a pinene-limonene-styrene copolymerization resin except an aromatic ring thereof is particularly preferable.

Furthermore, it is possible and preferable to use a compound that is liquid at 25° C. and a compound that is solid at 25° C., in combination, as a compound of Component 4 in order to balance between a viscosity of a polymerizable composition in Embodiment (II) of the present invention and an adhesive property of a polymerization product thereof to an object.

It is more preferable to use a compound that is liquid at 25° C. and further has 1 or less carbon-carbon unsaturated bond in a molecule thereof and a compound that is solid at 25° C. and does not have a carbon-carbon unsaturated bond in a molecule thereof, in combination.

In a case where a compound that is liquid at 25° C. and a compound that is solid at 25° C. is used in combination for Compoment 4, a preferable proportion of combinational use is 90:10-10:90 in a weight ratio, wherein 80:20-20:80 is more preferable.

It is preferable for an amount of Component 4 to be used in Embodiment (II) of the present invention to be 10-85% by weight relative to a total amount of a combination of Component 1, Component 2, and Component 4 that are essential components for Embodiment (II) of the present invention, wherein 15-82% by weight is more preferable and 20-80% by weight is particularly preferable. If an amount of Component 4 to be used in Embodiment (II) of the present invention is less than 10% by mass relative to a total amount of a combination of Component 1, Component 2, and Component 4 that are essential components for Embodiment (II) of the present invention, it may be impossible to obtain an effect of addition of Component 4 (that is, an effect of reduction of a rate of volume shrinkage at a time of polymerization), which is not necessarily preferable. Furthermore, if an amount of Component 4 to be used in Embodiment (II) of the present invention is greater than 85% by mass relative to a total amount of a combination of Component 1, Component 2, and Component 4 that are essential components for Embodiment (II) of the present invention, a strength of a coating film of a polymerization product obtained by polymerizing a polymerizable composition in Embodiment (II) of the present invention may be too low, which is not necessarily preferable.

It is possible and desirable for a polymerizable composition in Embodiment (I) of the present invention or a polymerizable composition in Embodiment (II) of the present invention to further include Component 5 described below, as moisture or heat resistance of a polymerization product in Embodiment (II) of the present invention or an adhesive sheet for optics in Embodiment (V) of the present invention as described below is taken into consideration.

Component 5: a(n) (meth)acryloyl-group-containing compound that has an alcoholic hydroxyl group.

Component 5 described above is not particularly limited as long as component 5 is a compound that has an alcoholic hydroxyl group and a(n) (meth)acryloyl group in 1 molecule thereof.

For a specific example of a(n) (meth)acryloyl-group-containing compound that has an alcoholic hydroxyl group (that is, Component 5), it is possible to provide, for example, 2-hydroxyethyl acrylate, 2-hydroxypropyl acrylate, 3-hydroxypropyl acrylate, 2-hydroxybutyl acrylate, 4-hydroxybutyl acrylate, 2-hydroxy-3-phenoxypropyl acrylate, 2-hydroxy-3-(o-phenylphenoxy)propyl acrylate, 2-hydroxyethyl acrylaminde, 2-hydroxyethyl methacrylate, 2-hydroxypropyl methacrylate, 3-hydroxypropyl methacrylate, 2-hydroxybutyl methacrylate, 4-hydroxybutyl methacrylate, 2-hydroxy-3-phenoxypropyl methacrylate, 2-hydroxy-3-(o-phenylphenoxy)propyl methacrylate, or the like.

Among these, 2-hydroxybutyl acrylate, 4-hydroxybutyl acrylate, 2-hydroxy-3-phenoxypropyl acrylate, 2-hydroxy-3-(o-phenylphenoxy)propyl acrylate, 2-hydroxypropyl methacrylate, 3-hydroxypropyl methacrylate, 2-hydroxybutyl methacrylate, or 4-hydroxybutyl methacrylate is preferable, as a compatibility is taken into consideration in a case of use in a polymerizable composition in Embodiment (I) of the present invention or a polymeirzable composition in Embodiment (II) of the present invention, wherein 4-hydroxybutyl acrylate, 2-hydroxypropyl methacrylate, 3-hydroxypropyl methacrylate, 2-hydroxybutyl methacrylate, or 4-hydroxybutyl methacrylate is more preferable, and 2-hydroxypropyl methacrylate is most preferable.

For an amount of Component 5 to be used, in a case where Component 5 is used in a polymerizable composition in Embodiment (I) of the present invention or a polymeirzable composition in Embodiment (II) of the present invention, it is preferable to be used at 1-12% by mass relative to a total amount of a polymerizable composition in Embodiment (I) of the present invention or a total amount of a polymerizable composition in Embodiment (II) of the present invention, wherein 2-10% by mass is more preferable and 3-8% by mass is even more preferable. If an amount of Component 5 to be used is less than 1% by mass relative to a total amount of a polymerizable composition in Embodiment (I) of the present invention or a total amount of a polymerizable composition in Embodiment (II) of the present invention, an effect of development of moisture or heat resistance may be low, which is not preferable. Furthermore, if an amount of Component 5 to be used is greater than 12% by mass relative to a total amount of a polymerizable composition in Embodiment (I) of the present invention or a total amount of a polymerizable composition in Embodiment (II) of the present invention, a polymerizable composition in Embodiment (I) of the present invention or a polymerizable composition in Embodiment (II) of the present invention may be clouded or a dielectric constant of a polymerization product obtained by polymerizing a polymerizable composition in Embodiment (I) of the present invention or a polymerizable composition in Embodiment (II) of the present invention may be too high, which is not necessarily preferable.

Furthermore, in a case where a polymerizable composition in Embodiment (II) of the present invention is used for a method for manufacturing an image display device in Embodiment (VI) of the present invention as described below, it is preferable for a rate of volume shrinkage at a time of polymerization of a polymerizable composition in Embodiment (II) of the present invention to be less than or equal to 3.5%, wherein it is more preferable to be less than or equal to 2.7% and it is most preferable to be less than or equal to 2.3%. If a rate of volume shrinkage at a time of polymerization of a polymerizable composition in Embodiment (II) of the present invention is greater than 3.5%, an internal stress stored in a polymerization product at a time when a poymerizable composition is polymerized is too large to cause a distortion on an interface between a polymerization product layer 5a or 5b and a display part 2, a protection part 3, or a touch panel 7 contacting it, which is not necessarily preferable.

A viscosity of a polymerizable composition in Embodiment (I) of the present invention or a polymeirzable composition in Embodiment (II) of the present invention at 25° C. is not particularly limited, and it is preferable to be less than or equal to 10000 mPa·s in view of handling thereof, wherein it is more preferable to be less than or equal to 7000 mPa·s and it is particularly preferable to be less than or equal to 5000 mPa·s.

Here, a viscosity described in the present specification, with respect to a composition with a viscosity less than or equal to 10000 mPa·seconds(s) at 25° C. is a value measured by using a cone/plate-type viscometer (produced by BROOKFIELD ASSET MANAGEMENT INC., model: DV-II+Pro, spindle number: CPE-42) on conditions of a temperature of 25.0° C. and a rotational frequency of 5 rpm.

As a viscosity of a polymerizable composition in Embodiment (I) of the present invention or a polymerizable composition in Embodiment (II) of the present invention at 25° C. is less than or equal to 10000 mPa·s, fluid spreading after application is facilitated in a case where a polymerizable composition in Embodiment (I) of the present invention or a polymeirzable composition in Embodiment (II) of the present invention is applied by a drawing application method that uses a dispenser, and as a result, spreading of such a composition with an uniform thickness at a location in need thereof is facilitated and further retardation of entrapment of an air bubble is facilitated.

It is possible and preferable to add a polymerization retarder or inhibitor or an antioxidant to a polymerizable composition in Embodiment (I) of the present invention or a polymeirzable composition in Embodiment (II) of the present invention.

A polymerization inhibitor or a polymerization retarder is not particularly limited as long as such a polymerization inhibitor or a polymerization retarder has a function of inhibiting a polymerization or retarding a polymerization, and it is possible to provide, for example, phenothiazine, hydroquinone, p-methoxyphenol, p-benzoquinone, naphthoquinone, phenanthraquinone, toluquinone, 2,5-diacetoxy-p-benzoquinone, 2,5-dicaproxy-p-benzoquinone, 2,5-acyloxy-p-benzoquinone, p-t-butylcatechol, 2,5-di-t-butylhydroquinone, p-tert-butylcatechol, mono-t-butylhydroquinone, 2,5-di-t-amylhydroquinone, di-t-butyl para-cresol hydroquinone monomethyl ether, alpha-naphthol, acetoamidine acetate, acetoamidine, sulfate, phenylhydrazine hydrochloride, hydrazine hydrochloride, trimethylbenzylammonium chloride, laurylpyridinium chloride, cetyltrimethylammonium chloride, phenyltrimethylammonium chloride, trimethylbenzylammonium oxalate, di(trimethylbenzylammonium)oxalate, trimethylbenzylammonium maleate, trimethylbenzylammonium tartarate, trimethylbenzylammonium glycolate, phenyl-β-naphtylamine, para-benzylaminophenol, di-β-naphthyl-para-phenylenediamine, dinitrobenzene, trinitrotoluene, picric acid, cyclohexanone oxime, pyrogallol, tannic acid, resorcin, triethylamine hydrochloride, dimethylaniline hydrochloride, dibutylamine hydrochloride, or the like.

It is possible to use these separately or two or more kinds thereof in combination appropriately.

Among these, hydroquinone, p-methoxyphenol, p-benzoquinone, naphthoquinone, phenanthraquinone, 2,5-diacetoxy-p-benzoquinone, 2,5-dicaproxy-p-benzoquinone, 2,5-acyloxy-p-benzoquinone, p-t-butylcatechol, 2,5-di-t-butylhydroquinone, p-tert-butylcatechol, mono-t-butylhydroquinone, 2,5-di-t-amylhydroquinone, di-t-butyl-para-cresol hydroquinone monomethyl ether, or phenothiazine is preferably used.

Usually, it is possible to adjust a polymerization inhibitor in such a manner that an amount of an added polymerization inhibitor is 0.01-5% by mass relative to a total amount of a polymerizable composition in Embodiment (I) of the present invention or a polymerizable composition in Embodiment (II) of the present invention. Herein, an amount of a polymerization inhibitor is a value that takes into account a polymerization inhibitor that is preliminarily included in Component 1, Component 2, or Component 5. That is, a polymerization inhibitor is preliminarily included in Component 1, Component 2, or Component 5 in general, and it is meant that a total amount or combinational amount of this polymerization inhibitor and a newly added polymerization inhibitor is an amount of an added polymerization inhibitor that is 0.01-5% by mass relative to a total amount of a polymerizable composition in Embodiment (I) of the present invention or a polymerizable composition in Embodiment (II) of the present invention.

An antioxidant is not particularly limited, and it is possible to provide, for example, pentaerythritol tetrakis[3-(3,5-di-tert-butyl-4-hydroxyphenyl)propionate], octadecyl 3-(3,5-di-tert-butyl-4-hydroxyphenyl)propionate, thiodiethylenebis[3-(3,5-di-tert-butyl-4-hydroxyphenyl)propioate], an alkyl ester with a carbon number of 7-9 of 3,5-di-tert-butyl-4-hydroxybenzenepropanoic acid, 4,6-bis(octylthiomethyl)-o-cresol, 3,9-bis[2-[3-(3-tert-butyl-4-hydroxy-5-methylphenyl)propionyloxy]-1,1-dimethylethyl]-2,4,8,10-tetraoxaspiro[5,5]-undecane, 2,2′-methylenebis(6-tert-butyl-4-methylphenol), 4,4′-butylidenebis(6-tert-butyl-3-methylphenol), 4,4′-thiobis(2-tert-butyl-5-methylphenol), N,N′,N″-tris(3,5-di-tert-butyl-4-hydroxybenzyl)isocyanurate, 1,1,3-tris(2-methyl-4-hydroxy-5-tert-butylphenyl)butane, 1,1-bis(2-methyl-4-hydroxy-5-tert-butylphenyl)butane, or the like. Among these, pentaerythritol tetrakis[3-(3,5-di-tert-butyl-4-hydroxyphenyl)propionate], or octadecyl 3-(3,5-di-tert-butyl-4-hydroxyphenyl)propionate is preferable, wherein pentaerythritol tetrakis[3-(3,5-di-tert-butyl-4-hydroxyphenyl)propionate] is most preferable.

Usually, it is possible to adjust an antioxidant in such a manner that an amount of an added antioxidant is 0.01-5% by mass relative to a total amount of a polymerizable composition in Embodiment (I) of the present invention or a polymerizable composition in Embodiment (II) of the present invention. Herein, an amount of an antioxidant is a value that takes into account an antioxidant that is preliminarily included in another component such as Component 4. That is, an antioxidant may be preliminarily included in Component 4 or the like in general, and it is meant that a total amount or combinational amount of this antioxidant and a newly added antioxidant is an amount of an added antioxidant that is 0.01-5% by mass relative to a total amount of a polymerizable composition in Embodiment (I) of the present invention or a polymerizable composition in Embodiment (II) of the present invention.

Next, Embodiment (III) of the present invention will be described.

Embodiment (III) of the present invention is a polymerization product obtained by polymerizing an polymerizable composition described in Embodiment (I) of the present invention or Embodiment (II) of the present invention.

A polymerization product in Embodiment (III) of the present invention is obtained by being irradiated with light to which a photopolymerization initiator is sensitive, through a glass or plastic substrate to polymerize a polymerizable composition while a light source is a low pressure mercury lamp, a medium pressure mercury lamp, a high pressure mercury lamp, an extra-high pressure mercury lamp, a xenon lamp, a metal halide lamp, an electrodeless lamp, an LED, or the like.

Furthermore, a polymerization product in Embodiment (III) of the present invention is a polymerization product that is used as a polymerization product layer to be interposed between an image display part of an image display device and a light-transmitting protection part. It is preferable for this polymerization product to be provided in such a manner that a dielectric constant of such a polymerization product with a thickness of 200 μm is less than or equal to 2.5 on conditions of 23° C., a frequency of 100 kHz, and an applied voltage of 100 mV and a value of a color coordinate b* of such an adjusted polymerization product with a thickness of 200 μm that is present between 2 glasses after an storage on conditions of 95° C. and 500 hours as described in JIS Z 8729 is less than 1.0.

Here, “a dielectric constant of a polymerization product on conditions of 23° C., a frequency of 100 kHz, and an applied voltage of 100 mV” as described in the present specification is a dielectric constant of a polymerization product on conditions of a frequency of 100 kHz and an applied voltage of 100 mV measured with respect to a test piece (polymerization product) with a thickness of 200 μm under an environment of 23° C. while 4294A Precision Impedance Analyzer 40 Hz-110 MHz produced by AGILENT TECHNOLOGIES, INC. is used as an impedance analyzer and 16451B Dielectric Test Fixture produced by AGILENT TECHNOLOGIES, INC. is used as a test fixture.

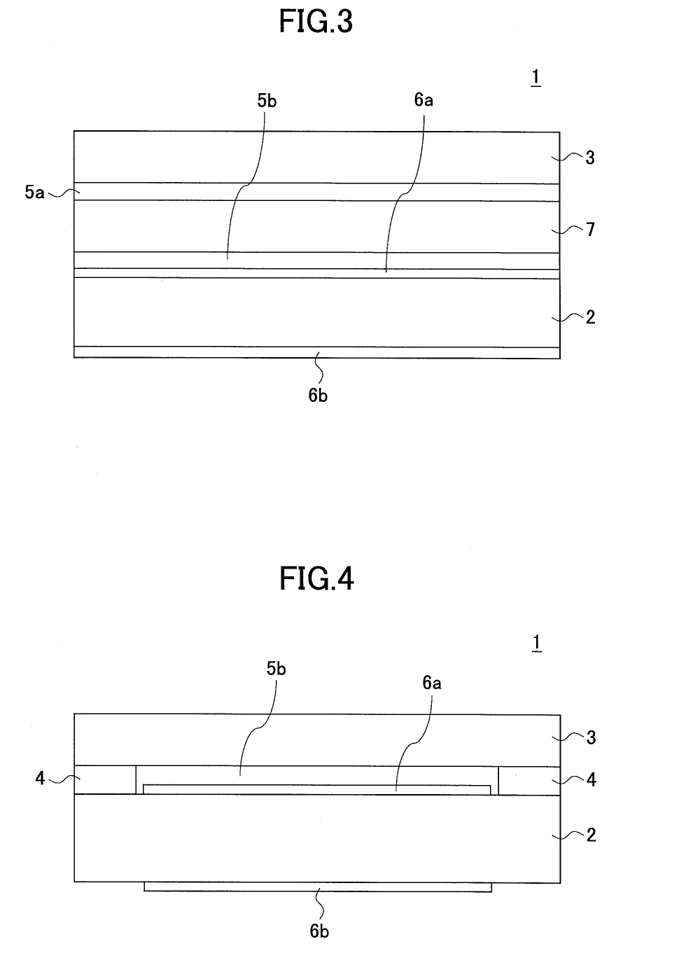

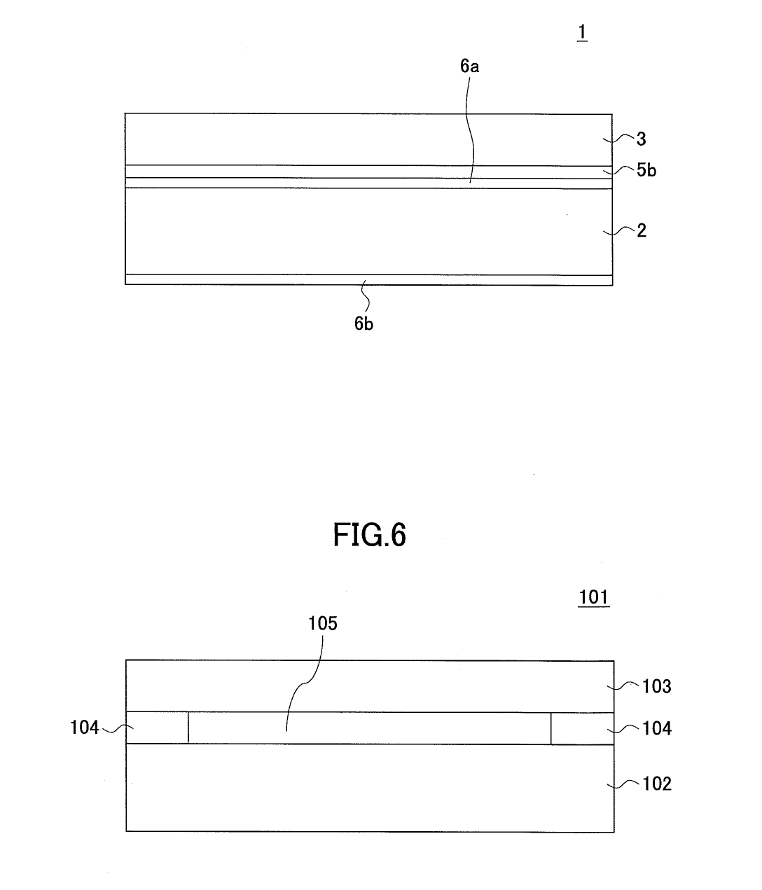

In a case where a polymerization product in Embodiment (III) of the present invention is used for a polymerization product (layer) filling between a display part and a touch panel of an add-on-type-electrostatic-capacitance-type-touch-panel-installing display device illustrated in FIG. 2 or FIG. 3 (a polymerization product (layer) 5b depicted in FIG. 2 or FIG. 3) or a polymerization product (layer) filling between a display part and a touch-sensor-integrating-type protection part of a cover-glass-touch-sensor-integrating-type-electrostatic-capacitance-type-touch-panel-installing display device (a polymerization product (layer) 5b depicted in FIG. 4 or FIG. 5), it is preferable for a dielectric constant of a polymerization product in Embodiment (III) of the present invention to be low. Specifically, it is preferable to use a polymerization product in such a manner that a dielectric constant of such a polymerization product with a thickness of 200 μm on conditions of 23° C., a frequency of 100 kHz, and an applied voltage of 100 mV is less than or equal to 2.5, wherein it is more preferable to use a polymerization product in such a manner that a dielectric constant of such a polymerization product with a thickness of 200 μm on conditions of 23° C., a frequency of 100 kHz, and an applied voltage of 100 mV is less than or equal to 2.4.

Furthermore, an “adjusted polymerization product with a thickness of 200 μm that is present between 2 glasses” as described in the present specification is a polymerization product that is obtained by interposing a 200 μm sheet-type polymerization product between 2 optical glasses with a thickness of 0.7 mm (produced by CORNING INCORPORATED, commercial name: EAGLE XG) or a polymerization product with a thickness of 200 μm that is obtained by interposing a polymerizable composition between 2 optical glasses with a thickness of 0.7 mm (produced by CORNING INCORPORATED, commercial name: EAGLE XG) and conducting irradiation with light to which a photopolymerization initiator is sensitive, through the optical glasses while a light source is a low pressure mercury lamp, a medium pressure mercury lamp, a high pressure mercury lamp, an extra-high pressure mercury lamp, a xenon lamp, a metal halide lamp, an electrodeless lamp, an LED, or the like, wherein a spacer, a gasket, a sealant, or the like is not contained at all in a part interposed by the 2 glasses outside a polymerization product layer.

Moreover, a “value of a color coordinate b* after an storage on conditions of 95° C. and 500 hours as described in JIS Z 8729” as described in the present specification is a value of a color coordinate (or psychometric chroma coordinate) b* of an adjusted polymerization product with a thickness of 200 μm that is present between the 2 glasses, as measured under an environment of 23° C. after storage under an environment of 95° C. for 500 hours in accordance with a method described in JIS Z 8729. Herein, a reference used for measuring this a value of b* is 1 optical glass with a thickness of 0.7 μm (produced by CORNING INCORPORATED, commercial name: EAGLE XG). In Embodiment (IV) of the present invention, it is necessary for a value of b* measured on the conditions described above to be less than 1.0. Moreover, it is preferable to be less than 0.9 and it is more preferable to be less than 0.8. As a value of b* measured on the conditions described above is greater than or equal to 1.0, a transmittance of a polymerization product with respect to light of 370-450 nm is decreased with time, which is not preferable.

It is preferable for a refractive index of a polymerization product in Embodiment (III) of the present invention at 25° C. to be 1.48-1.52. In a case where a refractive index of a polymerization product at 25° C. is less than 1.48 or greater than 1.52, a refractive index of a polymerization product is much lower than a refractive index of an optical glass or an acryl resin such as polymethyl methacrylate that is a material of a protection part, so that a refractive index difference at an interface between a display part and a protection part is slightly increased and scattering or attenuation of an image light from a display part is slightly increased, which is not necessarily preferable.

Furthermore, it is preferable for a tensional modulus of elasticity of a polymerization product in Embodiment (III) of the present invention at 23° C. to be less than or equal to 1×10⁷ Pa, wherein it is more preferable to be 1×10³ Pa-1×10⁶ Pa. As a tensional modulus of elasticity of a polymerization product at 23° C. is less than or equal to 1×10⁷ Pa, it is possible to prevent the occurrence of distortion in an image display part or a protection part due to an effect of stress caused by a volume shrinkage of a polymerizable composition at a time of polymerization thereof.

Here, a tensional modulus of elasticity described in the present specification is a value in a case where a test is conducted at a tension rate of 500 mm/minute.

Next, Embodiment (IV) of the present invention and Embodiment (V) of the present invention will be described.

Embodiment (IV) of the present invention is a polymerizable composition for manufacturing an adhesive sheet for optics that is used as a polymerization product layer to be interposed between an image display part of an image display device and a light-transmitting protection part, wherein the polymerizable composition is characterized in that the polymerizable composition is a polymerizable composition in Embodiment (I) of the present invention or Embodiment (II) of the present invention.

It is possible to manufacture an adhesive sheet for optics in Embodiment (V) of the present invention by using a polymerizable composition in Embodiment (I) of the present invention or a polymerizable composition in Embodiment (II) of the present invention as a raw material.

Embodiment (V) of the present invention is an adhesive sheet for optics that has a polymerization product layer with a thickness of 10-500 μm that is obtained by applying a polymerizable composition in Embodiment (IV) of the present invention and irradiating the composition with light to which a photopolymerization initiator is sensitive, to cause polymerization thereof.

An adhesive sheet for optics in Embodiment (V) of the present invention may be a double-sided adhesive sheet wherein both sides of such a sheet are adhesive faces (adhesive layer surfaces) or may be a single-sided adhesive sheet wherein only one side of such a sheet is an adhesive face (adhesive layer surface). Among those, it is preferable to be a double-sided adhesive sheet from the viewpoint of bonding of 2 members to each other. Here, an “adhesive sheet” in the present specification also includes a tape-like one, namely, an “adhesive tape”.

An adhesive sheet for optics in Embodiment (V) of the present invention may be an adhesive sheet for optics that does not have a substrate (substrate layer), namely, a “substrate-less type” one (that may be referred to as a “substrate-less adhesive sheet for optics” below), or may be an adhesive sheet for optics that has a substrate. For a substrate-less adhesive sheet for optics as described above, it is possible to provide, for example, a double-sided adhesive sheet for optics that is composed of polymerization product layers that are only composed of a polymerization product(s) in an embodiment of the present invention, a double-sided adhesive sheet that is composed of a polymerization product layer that is composed of a polymerization product in an embodiment of the present invention and an adhesive layer other than such a polymerization product layer. For a type of an adhesive sheet that has a substrate, it is sufficient to have a polymerization product layer that is composed of a polymerization product layer in an embodiment of the present invention, at least, at a side of one face of such a substrate. Among those, it is preferable to be a substrate-less adhesive sheet for optics (a substrate-less double-sided adhesive sheet for optics) from the viewpoint of thinning of such an adhesive sheet for optics or improvement of an optical property such as transparency, wherein it is more preferable to be a substrate-less double-sided adhesive sheet for optics that is composed of polymerization product layers that are only composed of a polymerization product(s) in an embodiment of the present invention. Here, a “substrate (substrate layer)” as described above does not include a separator (release liner) that is released at a time of use (adhesion) of an adhesive sheet.

A thickness of a polymerization product layer of an adhesive sheet for optics in Embodiment (V) of the present invention is 10-500 μm, wherein it is preferable to be 10-350 μm and it is more preferable to be 10-300 μm. If a thickness of a polymerization product layer is greater than 500 μm, a wrinkle may be caused at a time of winding thereof in an application process, or clouding may readily be caused by humidification, which is not necessarily preferable. If a thickness of a polymerization product layer is less than 10 μm, it may be impossible to disperse stress thereof because of a thin polymerization product layer, and releasing thereof may readily be caused.

An adhesive sheet for optics in Embodiment (V) of the present invention is used as a polymerization product layer to be interposed between an image display part of an image display device and a light-transmitting protection part. For example, in a case where an adhesive sheet for optics in Embodiment (V) of the present invention is used for a polymerization product (layer) filling between a display part and a touch panel of an add-on-type-electrostatic-capacitance-type-touch-panel-installing display device illustrated in FIG. 2 or FIG. 3 (a polymerization product (layer) 5b depicted in FIG. 2 or FIG. 3) or a polymerization product (layer) filling between a display part and a touch-sensor-integrating-type protection part of a cover-glass-touch-sensor-integrating-type-electrostatic-capacitance-type-touch-panel-installing display device (a polymerization product (layer) 5b depicted in FIG. 4 or FIG. 5), it is preferable for a dielectric constant of an adhesive sheet for optics in Embodiment (V) of the present invention to be low. Specifically, it is preferable to use an adhesive sheet for optics with a dielectric constant that is less than or equal to 2.5 at a thickness of 200 μm on conditions of 23° C., a frequency of 100 kHz, and an applied voltage of 100 mV, wherein it is more preferable to use an adhesive sheet for optics with a dielectric constant that is less than or equal to 2.4 at a thickness of 200 μm on conditions of 23° C., a frequency of 100 kHz, and an applied voltage of 100 mV.

It is preferable for a value of a color coordinate b* of such an adjusted adhesive sheet with a thickness of 200 μm that is present between 2 glasses after storage on conditions of 5° C. and 500 hours as described in JIS Z 8729 to be less than 1.0.

An adhesive sheet for optics in Embodiment (V) of the present invention is obtained by irradiating a polymerizable composition with light to which a photopolymerization initiator is sensitive, to cause polymerization thereof while a light source is a low pressure mercury lamp, a medium pressure mercury lamp, a high pressure mercury lamp, an extra-high pressure mercury lamp, a xenon lamp, a metal halide lamp, an electrodeless lamp, an LED, or the like.

In Embodiment (V) of the present invention, it is preferable for a value of b* measured on the conditions described above to be less than 1.0. Moreover, a value of b* measured on the conditions described above is preferably less than 0.9, and more preferably, less than 0.8. As a value of b* measured on the conditions described above is greater than or equal to 1.0, a transmittance of an adhesive sheet with respect to light at 370-450 nm is decreased with time, which is not preferable.

It is preferable for a refractive index of an adhesive sheet for optics in Embodiment (V) of the present invention at 25° C. to be 1.48-1.52. In a case where a refractive index of an adhesive sheet for optics at 25° C. to be less than 1.48 or greater than 1.52, a refractive index difference is too large when a refractive index of an adhesive sheet for optics is compared with a refractive index of an optical glass or an acryl resin such as polymethyl methacrylate that is a material of a protection part, so that a refractive index difference at an interface between a display part and a protection part is slightly large and scattering and attenuation of an image light from such a display part is slightly large, which is not necessarily preferable.

(Method for Forming a Polymerization Product Layer of an Adhesive Sheet for Optics)

A method for forming a polymerization product layer of an adhesive sheet for optics in Embodiment (V) of the present invention is not particularly limited in such a manner that it is possible to use a publicly known or commonly used method for forming a polymerization product layer, and in a case where a polymerization product layer of an adhesive sheet for optics is formed by polymerizing a polymerizable composition that has an acryloyl group such as a polymerizable composition in an embodiment of the present invention, it is possible to provide, for example, methods (1)-(3) described below or the like.

(1) A polymerization product layer is formed by applying (coating) a polymerizable composition that has an acryloyl group and includes a photopolymerization initiator or such a composition that further includes an additive according to a need, onto a substrate or a separator (release linear) and irradiating such a composition with light to which a photopolymerization initiator is sensitive, to cause polymerization thereof while a light source is used such as a low pressure mercury lamp, a medium pressure mercury lamp, a high pressure mercury lamp, an extra-high pressure mercury lamp, a xenon lamp, a metal halide lamp, an electrodeless lamp, or an LED.

(2) A polymerization product layer is formed by applying (coating) a polymerizable composition that has an acryloyl group and includes a photopolymerization initiator or such a composition (solution) that further includes a solvent and an additive according to a need, onto a substrate or a separator (release linear), conducting drying thereof, and irradiating such a composition with light to which a photopolymerization initiator is sensitive, to cause polymerization thereof while a light source is used such as a low pressure mercury lamp, a medium pressure mercury lamp, a high pressure mercury lamp, an extra-high pressure mercury lamp, a xenon lamp, a metal halide lamp, an electrodeless lamp, or an LED.

(3) The polymerization product layer formed in (1) described above is further dried.

Here, for application (coating) in the method for forming a polymerization product layer as described above, it is possible to use a publicly known coating method, wherein it is possible to use a commonly used coater, for example, a gravure roll coater, a reverse roll coater, a kiss-roll coater, a dip roll coater, a bar coater, a knife coater, a spray coater, a comma coater, a direct coater, or the like.

(Substrate)

In a case where an adhesive sheet for optics in Embodiment (V) of the present invention has a substrate, such a substrate is not particularly limited, and it is possible to provide, each kind of optical film such as a plastic film, an anti-reflection (AR) film, a polarizing plate, or a phase difference plate. For a material of the plastic film described above or the like, it is possible to provide, for example, a plastic material such as a polyester-type resin such as a polyethylene terephthalate (PET), an acryl-type resin such as polymethyl methacrylate (PMMA), polycarbonate, triacetylcellulose (TAC), polysulfone, polyallylate, polyimide, polyvinyl chloride, polyvinyl acetate, polyethylene, polypropylene, ethylene-propylene copolymer, or a cyclic-olefin-type polymer such as commercial name “ARTON” (a cyclic-olefin-type polymer; produced by JSR CORPORATION) or commercial name “ZEONOR” (a cyclic-olefin-type polymer; produced by ZEON CORPORATION). Here, it is possible to use a plastic material separately or 2 or more kinds thereof in combination. Furthermore, a “substrate” as described above is a part to be bonded to an object (such as an optical member) together with an adhesive layer in a case an adhesive sheet for optics is used for (bonded to) such an object. A separator (release linear) to be released from an adhesive sheet at a time of use (time of adhesion) is not included in a “substrate”.

Among those described above, it is preferable for a substrate to be a transparent substrate. It is preferable for a “transparent substrate” as described above to be, for example, a substrate with a total light ray transmittance in a visible light wavelength region (conformed to JIS K7361) that is greater than or equal to 85%, and it is more preferable to refer to a substrate with a total light ray transmittance in a visible light wavelength region that is greater than or equal to 88%. Furthermore, it is preferable for a haze of a substrate (conformed to JIS K7361) to be, for example, less than or equal to 1.5%, and it is more preferable to less than or equal to 1.0%. For the transparent substrate described above, it is possible to provide a PET film, a non-orientation film such as commercial name “ARTON” or commercial name “ZEONOR”, or the like.

A thickness of the substrate described above is not particularly limited and it is preferable to be, for example, 12-75 μm. Here, the substrate described above may have any form of a monolayer and a multilayer. Furthermore, for example, a publicly-known or commonly-used surface treatment such as a physical treatment such as a corona discharge treatment or a plasma treatment or a chemical treatment such as an undercoating treatment may appropriately be applied to a substrate surface.

In a case where an adhesive sheet for optics in Embodiment (V) of the present invention has a substrate, it is also possible to use each kind of functional film as such a substrate. In that case, an adhesive sheet in an embodiment of the present invention is an adhesive functional film that has an adhesive layer in an embodiment of the present invention, at least, at one face of a functional film. The functional film described above is not particularly limited, and it is possible to provide, for example, a film that has an optical function (such as a polarizing property, a light refracting property, a light reflecting property, a light transmitting property, a light absorbing property, a light diffracting property, an optically rotating property, or visibility), a film that has an electrical conductance (such as an ITO film), a film that has an ultraviolet ray cutting property, a film that has a hard-coat property (scratch resistance), or the like. More specifically, it is possible to provide, a hard-coat film (a film in which a hard-coat treatment is applied to at least one face of a plastic film such as a PET film), a light polarization film, a wave plate, a phase difference film, an optical compensation film, a brightness improvement film, a light guide plate, a reflection film, an anti-reflection film, a transparent and electrically conductive film (such as an ITO film), a design film, a decoration film, a surface protection film, a prism, a color filter, or the like. Here, each of a “plate” and a “film” as described above includes a plate-like, film-like, or sheet-like form or the like, wherein, for example, a “light polarization film” also includes a “light polarization plate” and a “light polarization sheet”. Furthermore, a “functional film” includes a “functional plate” and a “functional sheet”.

(Anther Additive Layer)

Furthermore, in a case where an adhesive sheet for optics in Embodiment (V) of the present invention has another additive layer, such another additive layer is not particularly limited, and it is possible to provide, for example, a publicly known or commonly used additive layer formed from an publicly known additive such as an urethane-type additive, an acryl-type additive, a rubber-type additive, a silicone-type additive, a polyester-type additive, a polyamide-type additive, an epoxy-type additive, a vinyl-alkyl-ether-type additive, or a fluorine-containing additive. It is possible to use the additive described above separately or 2 or more kinds thereof in combination.

Here, a polymerization product layer obtained by polymerizing a polymerizable composition in Embodiment (I) of the present invention or a polymerizable composition in Embodiment (II) of the present invention in a case where an additive sheet for optics in Embodiment (V) of the present invention does not include a substrate nor another additive layer, or a layer that combines a polymerization product layer obtained by polymerizing a polymerizable composition in Embodiment (I) of the present invention or a polymerizable composition in Embodiment (II) of the present invention with another additive layer in a case where such another additive layer is included, or a layer that combines a polymerization product layer obtained by polymerizing a polymerizable composition in Embodiment (I) of the present invention or a polymerizable composition in Embodiment (II) of the present invention with a substrate in a case where such a substrate is included, or a layer that combines a polymerization product layer obtained by polymerizing a polymerizable composition in Embodiment (I) of the present invention or a polymerizable composition in Embodiment (II) of the present invention with another additive layer and a substrate in a case where both such another additive layer and such a substrate are included, is defined as an “additive layer”.

(Separator)

An adhesive layer surface (adhesive face) of an adhesive sheet for optics in Embodiment (V) of the present invention may be protected with a separator (release liner) until a time of use thereof. Here, in a case where an adhesive sheet for optics in an embodiment of the present invention is a double-sided adhesive sheet, each adhesive face may be protected by 2 separators or may be protected in such a manner that it is a roll-like wrapped with 1 separator with both faces that are release faces. A separator is used as a protection material for an adhesive layer and is released at a time of bonding to an object. Furthermore, in a case where an adhesive sheet in an embodiment of the present invention is a substrate-less adhesive sheet, a separator also play a role of a supporter for an adhesive layer. Here, a separator may not necessarily be provided. The separator described above is not particularly limited and it is possible to use a commonly-used release paper or the like, wherein it is possible to use, for example, a substrate that has a release treatment layer, a low-adhesive substrate composed of a fluorine polymer, a low-adhesive substrate composed of a non-polar polymer, or the like. For the substrate that has a release treatment layer as described above, it is possible to provide, for example, a plastic film, a paper, or the like, that is surface-treated with a silicone-type, long-chain-alkyl-type, fluorine-type, or molybdenum sulfide release treatment, or the like. For a fluorine-containing polymer for the a low-adhesive substrate composed of a fluorine polymer as described above, it is possible to provide, for example, polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer, or the like. Furthermore, for the non-polar polymer described above, it is possible to provide, for example, an olefin-type resin (for example, polyethylene, polypropylene, or the like), or the like. Here, it is possible to form a separator in accordance with a publicly known or commonly used method. Furthermore, a thickness of a separator or the like is also not particularly limited.

It is preferable for a refractive index of an adhesive sheet for optics in Embodiment (V) of the present invention at 25° C. to be 1.48-1.52. In a case where a refractive index of an adhesive sheet for optics at 25° C. to be less than 1.48 or greater than 1.52, a refractive index of an adhesive sheet for optics is such that a refractive index difference is much larger as compared to a refractive index of an optical glass or an acryl resin such as polymethyl methacrylate that is a material of a protection part, so that a refractive index difference at an interface between a display part and a protection part is slightly large and scattering and attenuation of an image light from such an display part is slightly large, which is not necessarily preferable.

Next, Embodiment (VI) of the present invention will be described.

Embodiment (VI) of the present invention is a method for manufacturing an image display device that has a step of interposing and polymerizing a polymerizable composition between a base part having an image display part and a light-transmitting protection part to form a polymerization product layer, wherein the method for manufacturing an image display device has a step of interposing a polymerizable composition in Embodiment (II) of the present invention and irradiating with the composition with light to which a photopolymerization initiator is sensitive.

Here, “between a base part having an image display part and a light-transmitting protection part” described in the present specification means all of the parts between a base part having an image display part and a light-transmitting protection part, and for example, means that any location in polymerization product layers 5a and 5b in FIG. 2 is included in the expression of “between a base part having an image display part and a light-transmitting protection part”.

A preferable embodiment of an image display device will be described more specifically below, with reference to the drawings. Here, in each figure, an identical reference numeral indicates an identical or equivalent component.

For example, FIG. 1, FIG. 2, and FIG. 4 are cross-sectional diagrams that illustrate a main part of an image display device according to an embodiment of the present invention.

As illustrated in FIG. 1, FIG. 2, and FIG. 4, a display device 1 in the present embodiment has an image display part 2 that is connected to a not-illustrated driving circuit and conducts a predetermined image display, and a light-transmitting protection part 3 that opposes and is arranged close to or at a predetermined distance from this image display part 2.

Here, an “image display device” as described in the present specification is not particularly limited as long as such an image display device is a device for displaying an image, and it is possible to be applied to a variety thereof. For example, it is possible to provide a liquid crystal display device or an organic EL display device of a portable phone, a portable game machine, or the like. The image display part 2 in the present embodiment is a liquid crystal display panel of a liquid crystal display device.

Here, in a case where the image display part 2 is a liquid crystal display panel, its surfaces are provided with polarizing plates 6a and 6b as illustrated in FIG. 2 or FIG. 4.

In a method for manufacturing the image display device 1 in the present embodiment, for example, a spacer 4 and a non-illustrated jetty part are first provided on a marginal portion of the image display part 2 and a predetermined amount of a polyemrizable composition in Embodiment (II) of the present invention is dropped onto a region inside of them.

Then, the protection part 3 is arranged on the spacer 4 of the image display part 2 (liquid crystal display panel) and a polymerizable composition in Embodiment (II) of the present invention fills an air gap between the image display part (liquid crystal display panel) 2 and the protection part 3 without a space.

Subsequently, a polymerizable composition in Embodiment (II) of the present invention is irradiated with light to which Component 3 that is an essential component of the polymerizable composition in Embodiment (II) of the present invention is sensitive, through the protection part 3, and thereby, the polymerizable composition in Embodiment (II) of the present invention is polymerized. Thereby, the image display device 1 that is targeted is obtained.

According to this image display device 1, it is possible to enhance brightness or contrast and thereby improve visibility, because refractive indices of a polymerization product layer 5 and the protection part 3 are equivalent to each other.

Furthermore, it is possible to suppress an effect of stress caused by volume shrinkage of a polymerizable composition at a time of polymerization thereof on the image display part (liquid crystal display panel) 2 and the protection part 3 at a minimum so that distortion is hardly caused on the liquid crystal display panel 2 or the protection part 3, and as a result, deformation of the image display part (liquid crystal display panel) 2 is not caused so that it is possible to provide an image display with no defective display at high brightness and high contrast.

Furthermore, in a case where a polymerization product in Embodiment (III) is used for a polymerization product layer 5b in FIG. 2 or FIG. 4, a dielectric constant of a polymerization product for the polymerization product layer 5b is maintained to be low, and hence, even when a thickness of this polymerization product layer is reduced, it is possible to prevent malfunction of an image display device and it is possible to contribute to making of such an image display device thinner.

Next, Embodiment (VII) of the present invention will be described.

Embodiment (VII) of the present invention is a method for manufacturing an image display device that has a step of bonding a light-transmitting protection layer to a base having an image display part by using an adhesive sheet for optics, wherein the method for manufacturing an image display device is characterized in that the adhesive sheet for optics is an adhesive sheet for optics in Embodiment (V) of the present invention.

Here, “bonding a light-transmitting protection layer to a base having an image display part by using an adhesive sheet for optics” described in the present specification means that bonding of any portion between a base having an image display part and a light-transmitting protection layer is included in an expression of “bonding a light-transmitting protection layer to a base having an image display part by using an adhesive sheet for optics”, and for example, means that bonding of any of polymerization product layers 5a and 5b in FIG. 2 by using an adhesive sheet is included in an expression of “bonding a light-transmitting protection layer to a base having an image display part by using an adhesive sheet for optics”.

For a purpose of illustration of a step of bonding a light-transmitting protection layer to a base having an image display part by using an adhesive sheet for optics, a process for manufacturing a display device in FIG. 5 in such a manner that a first substrate is a touch-sensor-integrating-type protection part and a second substrate is a display part with a polarizing plate will be described as an example.

It is possible to conduct manufacturing thereof in accordance with a method that includes a step of arranging an adhesive sheet for optics in Embodiment (V) of the present invention adjacent to a side of a touch-sensor-mounting-face of a touch-sensor-integrating-type protection part that is a first substrate, a step of arranging a surface of a display part with a polarizing plate that is a second substrate adjacent to the adhesive sheet for optics in Embodiment (V) of the present invention, a step of heating and/or pressurizing the adhesive sheet for optics in Embodiment (V) of the present invention to conform to a step or a protrusion, and further, a step of irradiating the adhesive sheet for optics in Embodiment (V) of the present invention with light to which a photopolymerization initiator is sensitive, according to a need. It is possible to conduct these steps in various sequences.

For example, as one specific method, one face of an adhesive sheet for optics in Embodiment (V) of the present invention is first arranged adjacent to a side of a touch-sensor-mounting face of a touch-sensor-integrating-type protection part that is a first substrate, and a surface of a display part with a polarizing plate that is a second substrate is arranged adjacent to the other face of the adhesive sheet for optics in Embodiment (V) of the present invention. That is, an adhesive sheet for optics in Embodiment (V) of the present invention is interposed between a touch-sensor-integrating-type protection part (first substrate) and a display part with a polarizing plate (second substrate) in such a manner that a surface that has a step or a protrusion is directed to the adhesive sheet for optics in Embodiment (V) of the present invention. Then, an adhesive sheet for optics in Embodiment (V) of the present invention is heated and/or pressurized to cause the adhesive sheet to conform to a step or a protrusion. Subsequently, an adhesive sheet for optics in Embodiment (V) of the present invention is irradiated with light to which a photopolymerization initiator is sensitive, through these substrates from a side of a touch-sensor-integrating-type protection part (first substrate) and/or a side of a display part with a polarizing plate (second substrate) according to a need. Thus, it is possible to bond a display part with a polarizing plate (second substrate) to a touch-sensor-integrating-type protection part (first substrate) without forming an air gap near a step or a protrusion of the touch-sensor-integrating-type protection part (first substrate). Because a touch-sensor-integrating-type protection part (first substrate) and a display part with a polarizing plate (second substrate) are adjoined to an adhesive sheet for optics in Embodiment (V) of the present invention and subsequently such an adhesive sheet is heated and/or pressurized in this embodiment, it is also possible to cause such an adhesive sheet to conform to a step or a protrusion of the display part with a polarizing plate (second substrate) and thereby prevent formation of an air gap near such a shape in a case where there is such a step or a protrusion on a bonding surface of the display part with a polarizing plate (second substrate) (that is, a case where such an adhesive sheet is applied onto a polarizing plate mounted on an image display module).

In a case where irradiation with light to which a photopolymerization initiator is sensitive is conducted in the method described above, at least one of a first substrate and a second substrate is at least partially transparent in such a manner that it is possible to irradiate an adhesive sheet for optics in Embodiment (V) of the present invention with light to which a photopolymerization initiator is sensitive. As irradiation with an ultraviolet ray is conducted from a side of a first substrate in a case where a step or protrusion portion of the first substrate does not transmit an ultraviolet ray, irradiation with an ultraviolet ray is not conducted just under such a step or protrusion portion but polymerization of an adhesive sheet proceeds to some extent even on a non-irradiation portion due to transfer of a radical generated on a irradiated portion or the like.

For another specific method, one face of an adhesive sheet for optics in Embodiment (V) of the present invention is arranged to be adjacent to a touch-sensor-integrating-type protection part (first substrate) at a side of a surface that has a step or a protrusion (namely, a side of a touch-sensor-mounting face), and subsequently, such an adhesive sheet is heated and/or pressurized to cause such an adhesive sheet to conform to the step or the protrusion. Then, an open face of an adhesive sheet for optics in Embodiment (V) of the present invention is irradiated with an ultraviolet ray according to a need to further polymerize such an adhesive sheet, and subsequently, a display part with a polarizing plate (second substrate) is arranged to be adjacent to the other face of such an adhesive sheet so that the second substrate is bonded to such an adhesive sheet. In a case where a release film is transparent, it is also possible to irradiate an adhesive sheet with an ultraviolet ray through a release film according to a need. In this example, it is possible to an entire face of such an adhesive sheet with light to which a photopolymerization initiator is sensitive, and hence, it is possible to polymerize such an adhesive sheet more uniformly. In a case where a first substrate is at least partially transparent so that it is possible to be irradiated with light to which a photopolymerization initiator is sensitive that is necessary for polymerization of such an adhesive sheet, it is also possible to be irradiated with an ultraviolet ray from a side of the first substrate according to a need. Thus, it is possible to bond a first substrate and a second substrate to each other without forming an air gap near a step or a protrusion of the first substrate.

It is possible to conduct a heating step described above by using a convection-type oven, a hot plate, a heat laminator, an autoclave, or the like. In order to enhance a fluidity of an adhesive sheet so that the adhesive sheet is caused to conform to a step or a protrusion more efficiently, it is preferable to conduct heating and pressurizing simultaneously by using a heat laminator, an autoclave, or the like. Pressurizing by using an autoclave is particularly advantageous for degassing an adhesive sheet for optics. It is sufficient for a heating temperature for an adhesive sheet for optics in an embodiment of the present invention to be a temperature capable of softening or fluidizing such an adhesive sheet to conform to a step or a protrusion sufficiently, wherein, in general, it is possible to be higher than or equal to about 30° C., higher than or equal to about 40° C., or higher than or equal to about 60° C. and it is possible to be lower than or equal to about 150° C., lower than or equal to about 120° C., or lower than or equal to about 100° C. In a case where an adhesive sheet is pressurized, it is possible for an applied pressure to be, in general, higher than or equal to about 0.05 MPa or higher than or equal to about 0.1 MPa, and lower than or equal to about 2 MPa or lower than or equal to about 1 MPa.

It is possible to conduct the step of being irradiated with light to which a photopolymerization initiator is sensitive as described above that is conducted according to a need, by using a general ultraviolet ray irradiation device, for example, a belt-conveyor-type ultraviolet ray irradiation device that uses a low pressure mercury lamp, a medium pressure mercury lamp, a high pressure mercury lamp, an extra-high pressure mercury lamp, a xenon lamp, a metal halide lamp, an electrodeless lamp, or the like, as a light source. An amount of irradiation with an ultraviolet ray is generally about 1000 mJ/cm²-about 5000 mJ/cm².

Finally, Embodiment (VIII) of the present invention will be described.

Embodiment (VIII) of the present invention is an image display device manufactured by a method for manufacturing an image display device in Embodiment (VI) of the present invention or Embodiment (VII) of the present invention.

An image display device in Embodiment (VIII) of the present invention is such that, in a case where a body of such a display device is formed of an optical glass, its refractive index (n_{D}) is generally 1.49-1.52. Here, a reinforced glass with a refractive index (n_{D}) of about 1.55 is also present.

The protection part 3 is formed of a plate-shaped, sheet-shaped, or film-shaped light-transmitting member with a size similar to that of the display part 2. For this light-transmitting member, it is possible to use, for example, an optical glass or a plastic (such as an acryl resin such as polymethyl methacrylate) preferably. An optical layer such as an anti-reflection film, a light-blocking film, or a viewing angle control film may be formed on a front face or a back face of the protection part 3.

In a case where the protection part 3 is formed of an acryl resin, its refractive index (n_{D}) is generally 1.49-1.51.

The protection part 3 is provided on the display part 2 via a spacer 4 provided on a peripheral portion of the display part 2. A thickness of this spacer 4 is about 0.05-1.5 mm, and thereby, an inter-surface distance between the image display part 2 and the protection part 3 is kept to be about 1 mm.

Furthermore, a non-illustrated frame-like light-blocking part is provided on a peripheral portion of the protection part 3 in order to improve brightness and contrast.

First, an image display device manufactured by a method for manufacturing an image display device in Embodiment (VI) of the present invention will be described in detail.

Polymerization product layers 5a and 5b are interposed between the image display part 2 and the protection part 3. In a case of an image display device manufactured by a method for manufacturing an image display device in Embodiment (VI) of the present invention, a polymerization product in Embodiment (III) of the present invention is included in this polymerization product layer 5a or polymerization product layer 5b, and hence, a transmittance of the polymerization product layer 5a or the polymerization product layer 5b in an visible light region is higher than or equal to 90%. Herein, it is preferable for a thickness of the polymerization product layer 5a or the polymerization product layer 5b to be 10-500 μm. A thickness of the polymerization product layer 5a or the polymerization product layer 5b is more preferably 10-350 μm, and particularly preferably 10-300 μm.

Furthermore, a polymerization product in Embodiment (III) of the present invention is included in the polymerization product layer 5a or the polymerization product layer 5b, and hence, a refractive index (n_{D}) of the polymerization product layer 5a or the polymerization product layer 5b at 25° C. is 1.45-1.55 and preferably 1.48-1.52, so as to be approximately equivalent to an refractive index of the image display part 2 or the protection part 3, which is preferable. Thereby, it is possible to improve brightness or contrast of an image light from the image display part 2 and improve visibility thereof.

In a case where an image display device is manufactured by a method for manufacturing an image display device in Embodiment (VI) of the present invention, a polymerization product in Embodiment (III) of the present invention is included in the polymerization product layer 5a or the polymerization product layer 5b, and hence, a tensional modulus of elasticity of the polymerization product layer 5a or the polymerization product layer 5b at 23° C. is less than or equal to 1×10⁷ Pa, and is preferably 1×10³ Pa-1×10⁶ Pa. Therefore, it is possible to prevent the occurrence of distortion in an image display part or a protection part due to an effect of stress caused by a volume shrinkage of a polymerizable composition at a time of polymerization thereof.

In a case where an image display device is manufactured by a method for manufacturing an image display device in Embodiment (VI) of the present invention, a polymerization product in Embodiment (III) of the present invention is included in the polymerization product layer 5a or the polymerization product layer 5b, and hence, a rate of volume shrinkage of a polymerizable composition at a time of polymerization thereof is less than or equal to 4.0%, preferably less than or equal to 3.5%, more preferably less than or equal to 2.7%, and most preferably less than or equal to 2.3%. Thereby, it is possible to reduce an internal stress stored in a polymerization product layer at a time when a polymerizable composition is polymerized, and it is possible to prevent the occurrence of a distortion at an interface between the polymerization product layer 5a and a touch panel 7 or the protection part 3 or an interface between the polymerization product layer 5b and the touch panel 7, the display part 2, or the protection part 3. Therefore, in a case where a polymerizable composition is interposed between the touch panel 7 and the protection part 3, between the touch panel 7 and the display part 2, or between the display part 2 and the protection part 3, and such a polymerizable composition is polymerized, it is possible to reduce light scattering that is caused at an interface between the polymerization product layer 5 and the display part 2, the protection part 3, or the touch panel 7, and it is possible to improve brightness of a display image and improve visibility.

Furthermore, in a case where a polymerization product in Embodiment (III) of the present invention is used for the polymerization product layer 5b, it is possible to reduce a thickness of the polymerization product layer 5b because a dielectric constant of such a polymerization product is low.

Next, an image display device manufactured by a method for manufacturing an image display device in Embodiment (VII) of the present invention will be described.

Polymerization product layers 5a and 5b are interposed between the image display part 2 and the protection part 3. In a case of an image display device manufactured by a method for manufacturing an image display device in Embodiment (VII) of the present invention, an adhesive sheet for optics in Embodiment (V) of the present invention is included in this polymerization product layer 5a or polymerization product layer 5b, and hence, a transmittance of the polymerization product layer 5a or the polymerization product layer 5b in a visible light region is higher than or equal to 90%. Herein, it is preferable for a thickness of the polymerization product layer 5a or the polymerization product layer 5b to be 10-500 μm. A thickness of the polymerization product layer 5a or the polymerization product layer 5b is more preferably 10-350 μm, and particularly preferably 10-300 μm.

Furthermore, an adhesive sheet for optics in Embodiment (V) of the present invention is included in the polymerization product layer 5a or the polymerization product layer 5b, and hence, a refractive index (n_{D}) of the polymerization product layer 5a or the polymerization product layer 5b at 25° C. is 1.45-1.55, and preferably 1.48-1.52, that is approximately equivalent to a refractive index of the image display part 2 or the protection part 3, which is preferable. Thereby, it is possible to improve brightness or contrast of an image light from the image display part 2 and improve visibility thereof.

Furthermore, in a case where an image display device is manufactured by a method for manufacturing an image display device in Embodiment (VII) of the present invention, an adhesive sheet for optics in Embodiment (V) of the present invention is included in the polymerization product layer 5a or the polymerization product layer 5b, and hence, such an adhesive sheet is also caused to conform to a step or a protrusion of an image display part or a protection part so that it is possible to prevent formation of an air gap even near such a shape.

Furthermore, an adhesive sheet for optics in Embodiment (V) of the present invention has a flexibility, and hence, an internal residual stress of such a sheet, per se, is relaxed so that it is possible to prevent an irregularity in a display on an image display device even though the protection part 3, the display part 2, or the touch panel 7 has a concavoconvex shape or even when a layer that has an concavoconvex surface shape (for example, a polarizing plate) is further provided on a display face of an image display unit. For example, in a case of a display device in FIG. 4, an adhesive sheet for optics has a sufficient adhesive force and hydrophilicity, and hence, an air bubble or a release is not generated nor whitening is not caused at an interface between a display face (for example, a polarizing plate) of the image display part 2 and an adhesive sheet for optics (namely, the polymerization product layer 5b) or an interface between an adhesive sheet for optics (namely, the polymerization product layer 5b) and the touch-sensor-integrating-type protection part 3 even under an environment at high temperature and high humidity.

For an optical glass plate to be used for an image display device in Embodiment (VIII) of the present invention, it is possible to preferably use one that is used as a glass plate for interposing a liquid crystal of a liquid crystal cell or a protection plate for an liquid crystal cell. Furthermore, for an acryl resin plate to be used, it is possible to preferably use one that is used as a protection plate of a liquid crystal cell. An average surface roughness of such an optical glass plate or acryl resin plate is usually less than or equal to 1.0 nm.

Furthermore, an image display device in Embodiment (VIII) of the present invention is such that the polymerization product layer 5 that uses a polymerization product in Embodiment (III) of the present invention or an adhesive sheet for optics in Embodiment (V) of the present invention fills in between the image display part 2 and the protection part 3, and hence, is highly resistant against impact thereon.

In addition, it is possible to provide a thinner image display device than a conventional example wherein an air gap is provided between the image display part 2 and the protection part 3.

Furthermore, it is possible for an image display device in Embodiment (VIII) of the present invention to have various configurations. For example, the spacer 4 may be omitted to manufacture the image display device 1 as illustrated in FIG. 3 or FIG. 5. In a case of the polymerization product layer 5b in FIG. 3, an image display device is obtained by, for example, applying a photo-polymerizable composition in Embodiment (I) of the present invention or Embodiment (II) of the present invention onto a polarizing plate 6a on the display part 2, superposing the touch panel 7 thereon, and conducting photopolymerization thereof similarly to that described above, or for example, bonding a laminate composed of the protection part 3, the polymerization product layer 5a, the touch panel 7 and the polymerization product layer 5b (namely, an adhesive sheet for optics 5b) to a display face of the image display part 2 (namely, a surface of the polarizing palate 6a).

Furthermore, in a case of the polymerization product layer 5b in FIG. 5, an image display device is obtained by, for example, applying a photo-polymerizable composition in Embodiment (I) of the present invention or Embodiment (II) of the present invention onto a polarizing plate 6a on the display part 2, superposing the touch-sensor-integrating-type protection part 3 thereon, and conducting photopolymerization thereof similarly to that described above, or for example, bonding a laminate composed of the touch-sensor-integrating-type protection part 3 and the polymerization product layer 5b (namely, an adhesive sheet for optics 5b) to a display face of the image display part 2 (namely, a surface of the polarizing palate 6a).

Furthermore, it is possible to apply an embodiment of the present invention to, for example, various panel displays such as an organic EL and plasma display devices, as well as the liquid crystal display devices described above.

An embodiment of the present invention will further be described specifically below with reference to practical examples, and an embodiment of the present invention is not limited to only the following practical examples.

<Measurement of a Viscosity>

A viscosity was measured in accordance with the following method.

While 1 ml of a sample was used and a cone/plate-type viscometer (produced by BROOKFIELD ENGINEERING LABORATORIES, Model: DV-II+Pro, spindle model number: CPE-42) was used, a value was measured at a time when a viscosity was generally constant on conditions of a temperature of 25.0° C. and a rotational frequency of 5 rpm.

<Measurement of a Hydroxyl Value>

A hydroxyl value was measured to conform with JIS K 0070.

### Practical Synthesis Example 1

540.0 g of a hydrogenated polybutadiene polyol (produced by NIPPON SODA CO., LTD., commercial name: NISSO-PB GI-2000, hydroxyl value: 47.3 mgKOH/g), 162.0 g of n-butyl acrylate, 0.81 g of dioctyl tin dilaurate, and 3.51 g of pentaerythritol tetrakis[3-(3,5-di-tert-butyl-4-hydroxyphenyl)propionate] (produced by BASF, commercial name: IRGANOX1010) were thrown into a 1 liter four-necked flask with an agitator and a distillation unit, and a mixed liquid of n-butanol and n-butyl acrylate that was produced by heating at 130° C. was refluxed under air stream and gradually distilled out of a reaction system for about 10 hours simultaneously. After outflow of n-butanol and n-butyl acrylate was stopped, the interior of the reaction system was depressurized to 10 kPa by using a vacuum pump so that n-butanol and n-butyl acrylate was distilled out of the system again. After the reaction system was kept at 50 Pa for about 1.5 hours, a reactor was cooled to obtain acryloyl-group-containing hydrogenated polybutadiene 1.

### Practical Synthesis Example 2

540.0 g of a hydrogenated polybutadiene polyol (produced by NIPPON SODA CO., LTD., commercial name: NISSO-PB GI-3000, hydroxyl value: 29.5 mgKOH/g), 101.0 g of n-butyl acrylate, 0.81 g of dioctyl tin dilaurate, and 3.51 g of pentaerythritol tetrakis[3-(3,5-di-tert-butyl-4-hydroxyphenyl)propionate] (produced by BASF, commercial name: IRGANOX1010) were thrown into a 1 liter four-necked flask with an agitator and a distillation unit, and a mixed liquid of n-butanol and n-butyl acrylate that was produced by heating at 130° C. was refluxed under air stream and gradually distilled out of a reaction system for 10 about hours simultaneously. After outflow of n-butanol and n-butyl acrylate was stopped, the interior of the reaction system was depressurized to 10 kPa by using a vacuum pump so that n-butanol and n-butyl acrylate was distilled out of the system again. After the reaction system was kept at 50 Pa for about 1.5 hours, a reactor was cooled to obtain acryloyl-group-containing hydrogenated polybutadiene 2.

### Practical Synthesis Example 3

540.0 g of a hydrogenated polyisoprene polyol (produced by IDEMITSU KOSAN CO., LTD., commercial name: EPOL, hydroxyl value: 49.9 mgKOH/g), 162.0 g of n-butyl acrylate, 0.81 g of dioctyl tin dilaurate, and 3.51 g of pentaerythritol tetrakis[3-(3,5-di-tert-butyl-4-hydroxyphenyl)propionate] (produced by BASF, commercial name: IRGANOX1010) were thrown into a 1 liter four-necked flask with an agitator and a distillation unit, and a mixed liquid of n-butanol and n-butyl acrylate that was produced by heating at 130° C. was refluxed under air stream and gradually distilled out of a reaction system for about 10 hours simultaneously. After outflow of n-butanol and n-butyl acrylate was stopped, the interior of the reaction system was depressurized to 10 kPa by using a vacuum pump so that n-butanol and n-butyl acrylate was distilled out of the system again. After the reaction system was kept at 50 Pa for about 1.5 hours, a reactor was cooled to obtain acryloyl-group-containing hydrogenated polyisoprene 1.

### Practical Compounding Example 1

60.0 parts by mass of acryloyl-group-containing hydrogenated polyisoprene 1 described above, 40.0 parts by mass of isostearyl acrylate (produced by OSAKA ORGANIC CHEMICAL INDUSTRY LTD., commercial name: ISTA), 0.8 parts by mass of 1-hydroxycyclohexyl phenyl ketone (produced by BASF, commercial name: Irgacure 184), and 0.4 parts by mass of 2,4,6-trimethylbenzoyl-diphenylphosphineoxide (produced by LAMBSON JAPAN CO. LTD., commercial name: SpeedCure TPO) were mixed by using a rotation/revolution mixer (produced by THINKY CORPORATION, commercial name: Awatori Rentaro ARE-310). This compounded substance was referred to as polymerizable composition A1. A viscosity of polymerizable composition A1 at 25° C. was 4900 mPa·s.

### Practical Compounding Example 2

### Practical Compounding Example 9 and Comparative Compounding Example 1-Comparative Compounding Example 2

Compounding was made by a method similar to that of Practical Compounding Example 1 in accordance with a composition for compounding illustrated in Table 1. Compounded substances prepared in Practical Compounding Examples 2-9 were referred to as polymerizable composition A2-polymerizable composition A9, respectively, and compounded substances prepared in Comparative Compounding Example 1 and Comparative Compounding Example 2 were referred to as polymerizable composition B1 and polymerizable composition B2, respectively.

TABLE 1

| | Practical | Practical | Practical | Practical | Practical | Practical |
|---|---|---|---|---|---|---|
| | Compounding | Compounding | Compounding | Compounding | Compounding | Compounding |
| | Example 1 | Example 2 | Example 3 | Example 4 | Example 5 | Example 6 |
| | Polymerizable | Polymerizable | Polymerizable | Polymerizable | Polymerizable | Polymerizable |
| Name of compound | composition | composition | composition | composition | composition | composition |
| composition | A1 | A2 | A3 | A4 | A5 | A6 |
| Acryloyl-group- | | 60.0 | 30.0 | 25.0 | | |
| containing | | | | | | |
| hydrogenated | | | | | | |
| polybutadiene 1 | | | | | | |
| Acryloyl-group- | | | | | 20.0 | 20.0 |
| containing | | | | | | |
| hydrogenated | | | | | | |
| polybutadiene 2 | | | | | | |
| Acryloyl-group- | 60.0 | | | | | |
| containing | | | | | | |
| hydrogenated | | | | | | |
| polyisoprene | | | | | | |
| Urethane acrylate | | | | | | |
| SHIKOH UV-3000B | | | | | | |
| (*1) | | | | | | |
| Kuraprene | | | | | | |
| (registered | | | | | | |
| trademark) UC-203 | | | | | | |
| (*2) | | | | | | |
| Isobornyl acrylate | | | | | | |
| (*3) | | | | | | |
| Dicyclopentenyloxy- | | | | | | |
| ethyl methacrylate | | | | | | |
| (*4) | | | | | | |
| Lauryl acrylate | | | 25.0 | 19.0 | 20.0 | 14.5 |
| (*5) | | | | | | |
| Isostearyl acrylate | 40.0 | 36.0 | | | | |
| (*6) | | | | | | |
| 2-hydroxypropyl | | | | | | 3.5 |
| methacrylate (*7) | | | | | | |
| 4-hydroxybutyl | | 4.0 | | | | |
| acrylate (*8) | | | | | | |
| 2-hydroxybutyl | | | | | | |
| methacrylate (*9) | | | | | | |
| Terpene-type | | | 20.0 | | 14.0 | |
| hydrogenated resin | | | | | | |
| CLEARON (registered | | | | | | |
| trademark) P85 | | | | | | |
| (*10) | | | | | | |
| Terpene-type | | | 20.0 | | 14.0 | 24.0 |
| hydrogenated resin | | | | | | |
| CLEARON (registered | | | | | | |
| trademark) K100 | | | | | | |
| (*11) | | | | | | |
| Terpene-type | | | | | | |
| hydrogenated resin | | | | | | |
| CLEARON (registered | | | | | | |
| trademark) P105 | | | | | | |
| (*12) | | | | | | |
| Hydrogenated | | | | 40.0 | | 10.0 |
| polybutadiene | | | | | | |
| polyol NISSO-PB GI- | | | | | | |
| 1000 (*13) | | | | | | |
| Hydrogenated | | | | | 21.0 | 10.0 |
| polybutadiene | | | | | | |
| NISSO-PB BI-2000 | | | | | | |
| (*14) | | | | | | |
| Poly(α-olefin) | | | | 8.0 | 5.0 | 17.0 |
| liquid substance | | | | | | |
| Spectrasyn 40 (*15) | | | | | | |
| Ethylene-α-olefin | | | | | | |
| copolymerization | | | | | | |
| liquid substance | | | | | | |
| HC-40 (*16) | | | | | | |
| Liquid | | | | 7.0 | | |
| polybutadiene HV-35 | | | | | | |
| (*17) | | | | | | |
| Liquid | | | | | 5.0 | |
| polybutadiene | | | | | | |
| POLYVEST 110 (*18) | | | | | | |
| IRGANOX 1010 (*19) | | | 1.0 | 1.0 | 1.0 | 1.0 |
| Photopolymerization | 0.4 | 0.4 | 0.4 | 0.4 | 1.0 | 1.0 |
| initiator SpeedCure | | | | | | |
| TPO (*20) | | | | | | |
| Photopolymerization | 0.8 | 0.8 | 0.8 | 0.8 | | |
| initiator IRGACURE | | | | | | |
| 184 (*21) | | | | | | |
| Viscosity of | 4000 mPa · s | 4000 mPa · s | 6000 mPa · s | 4000 mPa · s | 3400 mPa · s | 3450 mPa · s |
| polymerizable | | | | | | |
| composition (25° C.) | | | | | | |

| | Practical | Practical | Practical | Comparative | Comparative |
|---|---|---|---|---|---|
| | Compounding | Compounding | Compounding | Compounding | Compounding |
| | Example 7 | Example 8 | Example 9 | Example 1 | Example 2 |
| | Polymerizable | Polymerizable | Polymerizable | Polymerizable | Polymerizable |
| Name of compound | composition | composition | composition | composition | composition |
| composition | A7 | A8 | A9 | B1 | B2 |
| Acryloyl-group- | 9.0 | 29.0 | 25.0 | | |
| containing | | | | | |
| hydrogenated | | | | | |
| polybutadiene 1 | | | | | |
| Acryloyl-group- | 21.0 | | | | |
| containing | | | | | |
| hydrogenated | | | | | |
| polybutadiene 2 | | | | | |
| Acryloyl-group- | | | | | |
| containing | | | | | |
| hydrogenated | | | | | |
| polyisoprene | | | | | |
| Urethane acrylate | | | | 50.0 | |
| SHIKOH UV-3000B | | | | | |
| (*1) | | | | | |
| Kuraprene | | | | | 70.0 |
| (registered | | | | | |
| trademark) UC-203 | | | | | |
| (*2) | | | | | |
| Isobornyl acrylate | | | | 30.0 | |
| (*3) | | | | | |
| Dicyclopentenyloxy- | | | | | 30.0 |
| ethyl methacrylate | | | | | |
| (*4) | | | | | |
| Lauryl acrylate | 14.5 | 22.5 | 16.0 | | |
| (*5) | | | | | |
| Isostearyl acrylate | | | | | |
| (*6) | | | | | |
| 2-hydroxypropyl | 3.5 | 3.5 | 3.5 | | |
| methacrylate (*7) | | | | | |
| 4-hydroxybutyl | | | | | |
| acrylate (*8) | | | | | |
| 2-hydroxybutyl | | | | | 10.0 |
| methacrylate (*9) | | | | | |
| Terpene-type | | 20.0 | | | 30.0 |
| hydrogenated resin | | | | | |
| CLEARON (registered | | | | | |
| trademark) P85 | | | | | |
| (*10) | | | | | |
| Terpene-type | 24.0 | 20.0 | | | |
| hydrogenated resin | | | | | |
| CLEARON (registered | | | | | |
| trademark) K100 | | | | | |
| (*11) | | | | | |
| Terpene-type | | | | | |
| hydrogenated resin | | | | | |
| CLEARON (registered | | | | | |
| trademark) P105 | | | | | |
| (*12) | | | | | |
| Hydrogenated | 12.0 | | 39.5 | | |
| polybutadiene | | | | | |
| polyol NISSO-PB GI- | | | | | |
| 1000 (*13) | | | | | |
| Hydrogenated | | | | | |
| polybutadiene | | | | | |
| NISSO-PB BI-2000 | | | | | |
| (*14) | | | | | |
| Poly(α-olefin) | | | 8.0 | | |
| liquid substance | | | | | |
| Spectrasyn 40 (*15) | | | | | |
| Ethylene-α-olefin | 15.0 | | | | |
| copolymerization | | | | | |
| liquid substance | | | | | |
| HC-40 (*16) | | | | | |
| Liquid | | | 7.0 | | |
| polybutadiene HV-35 | | | | | |
| (*17) | | | | | |
| Liquid | | | | | 140.0 |
| polybutadiene | | | | | |
| POLYVEST 110 (*18) | | | | | |
| IRGANOX 1010 (*19) | 1.0 | 1.0 | 1.0 | | 0.3 |
| Photopolymerization | 1.0 | 0.4 | 0.4 | 1.0 | 0.5 |
| initiator SpeedCure | | | | | |
| TPO (*20) | | | | | |
| Photopolymerization | | 0.8 | 0.8 | 3.0 | 4.0 |
| initiator IRGACURE | | | | | |
| 184 (*21) | | | | | |
| Viscosity of | 3550 mPa · s | 6000 mPa · s | 4000 mPa · s | 3000 mPa · s | 3500 mPa · s |
| polymerizable | | | | | |
| composition (25° C.) | | | | | |

*1 Urethane acrylate SHIKOH UV-3000B (a polyester-type urethane acrylate produced by NIPPON SYNTHETIC CHEMICAL INDUSTRY CO., LTD.)
*2 Kuraprene UC-203 (an ester from a maleic anhydride adduct of a polyisoprene polymer and 2-hydroxyethyl methacrylate produced by KURARAY CO., LTD.)
*3 Isobornyl acrylate (trade name: IBXA produced by OSAKA ORGANIC CHEMICAL INDUSTRY LTD.)
*4 Dicyclopentenyloxyethyl methacrylate (trade name: FA-512M produced by HITACHI CHEMICAL CO., LTD.)
*5 Lauryl acrylate (trade name: BLEMMER LA produced by NOF CORPORATION)
*6 Isostearyl acrylate (trade name: ISTA produced by OSAKA ORGANIC CHEMICAL INDUSTRY LTD.)
*7 2-hydroxypropyl methacrylate (trade name: HPMA produced by MITSUBISHI RAYON CO., LTD.)
*8 4-hydroxybutyl acrylate (trade name: 4HBA produced by OSAKA ORGANIC CHEMICAL INDUSTRY LTD.)
*9 2-hydroxybutyl methacrylate (trade name: LIGHT ESTER HOB(N) produced by KYOEISHA CHEMICAL CO., LTD.)
*10 Terpene-type hydrogenated resin CLEARON (registered trademark) P85 (produced by YASUHARA CHEMICAL CO., LTD.)
*11 Terpene-type hydrogenated resin CLEARON (registered trademark) K100 (produced by YASUHARA CHEMICAL CO., LTD.)
*12 Terpene-type hydrogenated resin CLEARON (registered trademark) M105 (produced by YASUHARA CHEMICAL CO., LTD.)
*13 Hydrogenated polybutadiene polyol NISSO-PB GI-1000 (produced by NIPPON SODA CO., LTD.)
*14 Hydrogenated polybutadiene NISSO-PB BI-2000 (produced by NIPPON SODA CO., LTD.)
*15 Poly(α-olefin) liquid substance Spectrasyn 40 (produced by EXXON MOBIL CORPORATION)
*16 Ethylene-α-olefin copolymerization liquid substance HC-40 (produced by MITSUI CHEMICALS, INC.)
*17 Liquid polybutadiene HV-35 (produced by JX NIPPON OIL & ENERGY CORPORATION)
*18 Liquid polybutadiene POLYVEST 110 (produced by EVONIK DEGUSSA)
*19 IRGANOX 1010 (compound name: pentaerythritol tetrakis[3-(3,5-di-tert-butyl-4-hydroxyphenyl)propionate] produced by BASF)
*20 Photopolymerization initiator SpeedCure TPO (compound name: 2,4,6-trimethylbenzoyldiphenylphosphineoxide produced by Lambson)
*21 Photopolymerization initiator IRGACURE 184 (compound name: 1-hydroxycyclohexyl phenyl ketone produced by BASF)

### <Manufacturing of an Adhesive Sheet for Optics>

After each of polymerizable composition A1-polymerizable composition A9, polymerizable composition B1, and polymerizable composition B2 illustrated in Table 1 was applied onto a silicone-coated polyethylene terephthalate (that will be noted as “PET” below) film (100 mm×100 mm×50 μm) by using an applicator so that a film thickness thereof was 200 μm, and a top face thereof was covered with a silicone-coated PET film with a thickness of 25 μm, such a polymerizable composition was irradiated with ultraviolet rays by using a conveyor-type ultraviolet ray irradiation apparatus (produced by GS YUASA POWER SUPPLY LTD. LIGHTING BUSINESS UNIT, commercial name: GSN2-40) with the use of a metal halide lamp, through the silicone-coated PET film, on conditions of an irradiation intensity of 190 mW/cm² (a value at 365 nm) and an amount of irradiation of 2800 mJ/cm² (a value at 365 nm) to cause polymerization thereof, so that an adhesive sheet for optics with a film thickness of about 200 μm interposed between release PET films was obtained. The above-mentioned adhesive sheets for optics that were manufactured by using polymerizable composition A1-polymerizable composition A9, polymerizable composition B1, and polymerizable composition B2 were referred to as adhesive sheet A1-adhesive sheet A9, adhesive sheet B1, and adhesive sheet B2, respectively.

<Method for Preparing a Test Piece by Using the Above-Mentioned Adhesive Sheet and Evaluation of an Initial Optical Property Thereof>

For each of adhesive sheet A1-adhesive sheet A9, adhesive sheet B1, and adhesive sheet B2 described above, a test piece was prepared by bonding 2 glass plates (50 mm×50 mm×0.7 mm, the kind of glass, commercial name: EAGLE XG (trademark), produced by CORNING INCORPORATED) to the adhesive sheet in such a manner that both faces of the adhesive sheet are interposed between the 2 glass plates so as not to incorporate an air bubble at an interface thereof.

Test pieces prepared by using adhesive sheet A1-adhesive sheet A9, adhesive sheet B1, and adhesive sheet B2 were referred to as test piece AS1-test piece AS9, test piece BS1, and test piece BS2, respectively. Total light ray transmittances and b*s of these test pieces were measured by a method described below. Those results are illustrated in Table 3.

<Method for Preparing a Test Piece and Evaluation of an Initial Optical Property Thereof>

Each of polymerizable composition A3-polymerizable composition A9, polymerizable composition B1, and polymerizable composition B2 is applied onto a glass plate (50 mm×50 mm×0.7 mm, the kind of glass, commercial name: EAGLE XG (trademark), produced by CORNING INCORPORATED) by using a bar coater to provide a film thickness thereof of 200 μm, then interposed by glass plates with an identical kind and an identical shape, and irradiated with ultraviolet rays by using a conveyor-type ultraviolet rat irradiation apparatus (produced by GS YUASA POWER SUPPLY LTD. LIGHTING BUSINESS UNIT, commercial name: GSN2-40) with the use of a metal halide lamp, through the glass plates, on conditions of an irradiation intensity of 190 mW/cm² (a value at 365 nm) and an amount of irradiation of 2800 mJ/cm² (a value at 365 nm) to polymerize such a polymerizable composition, so that a polymerization product film for an evaluation test with a film thickness of about 200 μm interposed between the glass plates was obtained. Polymerization product films for an evaluation test with a film thickness of about 200 μm interposed between the glass plates that were manufactured by using polymerizable compositions A3-A9, polymerizable composition B1, and polymerizable composition B2 were referred to as test piece AL3-test piece AL9, test piece BL1, and test piece BL2, respectively. Total light ray transmittances and b*s of these test pieces were measured by a method described below. Those results are illustrated in Table 3.

<Measurement of a Total Light Ray Transmittance>

While 1 glass plate (50 mm×50 mm×0.7 mm, the kind of glass, commercial name: EAGLE XG (trademark), produced by CORNING INCORPORATED) was used as a reference, total light ray transmittances of test piece AS1-test piece AS9, test piece AL3-test piece AL9, test piece BS1, test piece BS2, test piece BL1, and test piece BL2 described above were measured in conformity with JIS K 7361-1. Those results were illustrated in Table 3.

<Measurement of a b*>

While 1 glass plate (50 mm×50 mm×0.7 mm, the kind of glass, commercial name: EAGLE XG (trademark), produced by CORNING INCORPORATED) was used as a reference, b*s of test piece AS1-test piece AS9, test piece AL3-test piece AL9, test piece BS1, test piece BS2, test piece BL1, and test piece BL2 described above were measured in conformity with JIS Z 8729. Those results were illustrated in Table 3.

<Measurement of a Haze>

While 1 glass plate (50 mm×50 mm×0.7 mm, the kind of glass, commercial name: EAGLE XG (trademark), produced by CORNING INCORPORATED) was used as a reference, hazes of test piece AS1-test piece AS9, test piece AL3-test piece AL9, test piece BS1, test piece BS2, test piece BL1, and test piece BL2 described above were measured in conformity with JIS K 7136. Those results were illustrated in Table 3.

<Measurement of a Dielectric Constant>

By using 2 silicone-coated PET films, each of polymerizable composition A1-polymerizable composition A9, polymerizable composition B1 and polymerizable composition B2 is interposed therebetween so that a film thickness thereof is 200 μm, and such a polymerizable composition is irradiated with ultraviolet rays by using a conveyor-type ultraviolet ray irradiation apparatus (produced by GS YUASA POWER SUPPLY LTD. LIGHTING BUSINESS UNIT, commercial name: GSN2-40) with the use of a metal halide lamp, through the silicone-coated PET films, on conditions of an irradiation intensity of 190 mW/cm² (a value at 365 nm) and an amount of irradiation of 2800 mJ/cm² (a value at 365 nm) to cause polymerization thereof, so that a polymerization product film for an evaluation test with a film thickness of about 200 μm interposed between the silicone-coated PET films. This polymerization product film was released from the silicone-coated PET films and a dielectric constant of the polymerization product film was measured by using an impedance analyzer (produced by AGILENT TECHNOLOGIES, INC., commercial name: 4294A Precision Impedance Analyzer 40 Hz-110 MHz). Those results are illustrated in Table 2.

Here, polymerization product films with a thickness of 200 μm obtained by polymerizing polymerizable composition A1-polymerizable composition A9, polymerizable composition B1, and polymerizable composition B2 wherein the silicone-coated PET films were released were referred to as polymerization product film A1-polymerization product film A9, polymerization product film B1, and polymerization product film B2, respectively.

<Measurement of a Rate of Volume Shrinkage at a Time of Polymerization Thereof>

Densities of Polymerizable compositions A1-A9, polymerizable composition B1, and polymerizable composition B2 before polymerization and polymerization products obtained by polymerization thereof in accordance with a manufacturing method described below were measured by using an automatic hydrometer (model: DMA-220H, produced by SHINKO DENSHI CO., LTD.) at a temperature condition of 23° C., and a rate of volume shrinkage at a time of polymerization was obtained from a formula described below.

(Method for manufacturing a polymerization product used for a measurement of a rate of volume shrinkage at a time of polymerization thereof)

Each composition of polymerizable composition A1-polymerizable composition A9, polymerizable composition B1, and polymerizable composition B2 is interposed so that a film thickness thereof is about 2 mm, and such a polymerizable composition is irradiated with ultraviolet rays by using a conveyor-type ultraviolet ray irradiation apparatus (produced by GS YUASA POWER SUPPLY LTD. LIGHTING BUSINESS UNIT, commercial name: GSN2-40) with the use of a metal halide lamp, through silicone-coated PET films, on conditions of an irradiation intensity of 190 mW/cm² (a value at 365 nm) and an amount of irradiation of 4000 mJ/cm² (a value at 365 nm) to cause polymerization thereof, so that a polymerization product film for an evaluation test with a film thickness of about 2 mm between the silicone-coated PET films was obtained. This polymerization product film was released from the silicone-coated PET films and these polymerization products were used for measurements of densities thereof.

A rate of volume shrinkage at a time of polymerization(%)=[(a density of a polymerization product−a density of polymerizable composition)/(a density of a polymerization product)]×100

Those results are illustrated in Table 2.

<Measurement of a Refractive Index>

Polymerization product film A1-polymerization product film A9, polymerization product film B1, and polymerization product film B2 described above were used to measure refractive indices of such polymerization product films in conformity with JIS K 7105. Those results are illustrated in Table 2.

<Measurement of a Tensional Modulus of Elasticity>

Each of polymerization product film A1-polymerization product film A9, polymerization product film B1, and polymerization product film B2 described above was fixed on a tension tester (produced by SHIMADZU CORPORATION, EZ Test/CE) and a test was conducted at 23° C. and a tension speed of 500 mm/minute to obtain a tensional modulus of elasticity of a polymerization product film. Those results are illustrated in Table 2.

<Measurement of a Total Light Ray Transmittance, a b* Value, and a Haze in a Case of Storage Under High Temperature Condition>

Each of test piece AS1-test piece AS9, test piece AL3-test piece AL9, test piece BS1, test piece BS2, test piece BL1, and test piece BL2 described above was put in a thermostat at 70° C., 85° C., and 95° C., and such a test piece after passage of 500 hours was used in a method described above to measure a total light ray transmittance, a b* value, and a haze of the test piece. Those results are illustrated in Table 3.

<Measurement of a Total Light Ray Transmittance, a b* Value, and a Haze in a Case of Storage Under a High Temperature and Humidity Condition>

Each of test piece AS1-test piece AS9, test piece AL3-test piece AL9, test piece BS1, test piece BS2, test piece BL1, and test piece BL2 described above was put in a thermo-hygrostat at a temperature of 60° C. and a humidity of 90% RH, and such a test piece after passage of 500 hours was used in a method described above to measure a total light ray transmittance, a b* value, and a haze of the test piece. Those results are illustrated in Table 3.

TABLE 2

| | Name of used polymerizable composition | | | | | |
|---|---|---|---|---|---|---|
| | Polymerizable | Polymerizable | Polymerizable | Polymerizable | Polymerizable | Polymerizable |
| | composition | composition | composition | composition | composition | composition |
| | A1 | A2 | A3 | A4 | A5 | A6 |
| | Name of used polymerization product film | | | | | |
| | Polymerization | Polymerization | Polymerization | Polymerization | Polymerization | Polymerization |
| | product film | product film | product film | product film | product film | product film |
| | A1 | A2 | A3 | A4 | A5 | A6 |
| Rate of volume | 4.0% | 4.1% | 2.6% | 2.2% | 2.0% | 1.9% |
| shrinkage at | | | | | | |
| time of | | | | | | |
| polymerization | | | | | | |
| (23° C.) | | | | | | |
| Refractive index | 1.49 | 1.49 | 1.50 | 1.49 | 1.50 | 1.50 |
| n_{D} of | | | | | | |
| polymerization | | | | | | |
| product film | | | | | | |
| (25° C.) | | | | | | |
| Tensional | 1.2 × 10⁵ Pa | 1.3 × 10⁵ Pa | 1.3 × 10⁵ Pa | 1.2 × 10⁵ Pa | 0.6 × 10⁵ Pa | 0.9 × 10⁵ Pa |
| modulus of | | | | | | |
| elasticity | | | | | | |
| (23° C.) | | | | | | |
| Dielectric | 2.3 | 2.3 | 2.4 | 2.4 | 2.4 | 2.4 |
| constant (23° C., | | | | | | |
| 100 kHz, 100 mV) | | | | | | |

| | Name of used polymerizable composition | | | | |
|---|---|---|---|---|---|
| | Polymerizable | Polymerizable | Polymerizable | Polymerizable | Polymerizable |
| | composition | composition | composition | composition | composition |
| | A7 | A8 | A9 | B1 | B2 |
| | Name of used polymerization product film | | | | |
| | Polymerization | Polymerization | Polymerization | Polymerization | Polymerization |
| | product film | product film | product film | product film | product film |
| | A7 | A8 | A9 | B1 | B2 |
| Rate of volume | 2.0% | 2.6% | 2.2% | 4.5% | 1.8% |
| shrinkage at | | | | | |
| time of | | | | | |
| polymerization | | | | | |
| (23° C.) | | | | | |
| Refractive index | 1.50 | 1.50 | 1.49 | 1.47 | 1.52 |
| n_{D} of | | | | | |
| polymerization | | | | | |
| product film | | | | | |
| (25° C.) | | | | | |
| Tensional | 1.9 × 10⁵ Pa | 1.3 × 10⁵ Pa | 1.2 × 10⁵ Pa | 1.0 × 10⁶ Pa | 1.0 × 10⁴ Pa |
| modulus of | | | | | |
| elasticity | | | | | |
| (23° C.) | | | | | |
| Dielectric | 2.5 | 2.4 | 2.4 | 3.0 | 2.7 |
| constant (23° C., | | | | | |
| 100 kHz, 100 mV) | | | | | |

TABLE 3

| | | Temperature condition | | | |
|---|---|---|---|---|---|
| | | | | | 60° C., |
| | | 70° C. | 85° C. | 95° C. | 90% RH |
| | | Immediately after | | | |
| | | polymerization (after 0 hours) | | | |
| Test | b* | 0.18 | 0.16 | 0.14 | 0.14 |
| piece | Total light ray | 99.8 | 99.8 | 99.8 | 99.8 |
| AS1 | transmittance | | | | |
| | Haze | 0.0 | 0.0 | 0.0 | 0.0 |
| Test | b* | 0.24 | 0.24 | 0.22 | 0.21 |
| piece | Total light ray | 99.8 | 99.8 | 99.8 | 99.8 |
| AS2 | transmittance | | | | |
| | Haze | 0.0 | 0.0 | 0.0 | 0.0 |
| Test | b* | 0.20 | 0.18 | 0.16 | 0.14 |
| piece | Total light ray | 99.8 | 99.8 | 99.8 | 99.8 |
| AS3 | transmittance | | | | |
| | Haze | 0.0 | 0.0 | 0.0 | 0.0 |
| Test | b* | 0.19 | 0.16 | 0.18 | 0.14 |
| piece | Total light ray | 99.8 | 99.8 | 99.8 | 99.8 |
| AS4 | transmittance | | | | |
| | Haze | 0.0 | 0.0 | 0.0 | 0.0 |
| Test | b* | 0.17 | 0.17 | 0.18 | 0.14 |
| piece | Total light ray | 99.7 | 99.8 | 99.9 | 99.8 |
| AS5 | transmittance | | | | |
| | Haze | 0.1 | 0.1 | 0.1 | 0.1 |
| Test | b* | 0.18 | 0.16 | 0.17 | 0.16 |
| piece | Total light ray | 99.8 | 99.8 | 99.9 | 99.9 |
| AS6 | transmittance | | | | |
| | Haze | 0.0 | 0.0 | 0.0 | 0.0 |
| Test | b* | 0.20 | 0.23 | 0.25 | 0.22 |
| piece | Total light ray | 99.8 | 99.8 | 99.8 | 99.8 |
| AS7 | transmittance | | | | |
| | Haze | 0.0 | 0.0 | 0.0 | 0.0 |
| | | After 500 hours | | | |
| Test | b* | 0.19 | 0.35 | 0.36 | 0.34 |
| piece | Total light ray | 99.8 | 99.7 | 99.7 | 99.7 |
| AS1 | transmittance | | | | |
| | Haze | 0.0 | 0.1 | 0.1 | 4.0 |
| Test | b* | 0.28 | 0.40 | 0.40 | 0.30 |
| piece | Total light ray | 99.9 | 99.8 | 99.8 | 99.7 |
| AS2 | transmittance | | | | |
| | Haze | 0.0 | 0.0 | 0.1 | 0.1 |
| Test | b* | 0.22 | 0.35 | 0.37 | 0.34 |
| piece | Total light ray | 99.8 | 99.7 | 99.7 | 99.7 |
| AS3 | transmittance | | | | |
| | Haze | 0.0 | 0.1 | 0.1 | 4.0 |
| Test | b* | 0.21 | 0.34 | 0.36 | 0.34 |
| piece | Total light ray | 99.8 | 99.7 | 99.7 | 99.7 |
| AS4 | transmittance | | | | |
| | Haze | 0.0 | 0.1 | 0.1 | 4.0 |
| Test | b* | 0.18 | 0.31 | 0.71 | 0.43 |
| piece | Total light ray | 99.8 | 99.8 | 99.6 | 99.5 |
| AS5 | transmittance | | | | |
| | Haze | 0.1 | 0.1 | 0.1 | 0.3 |
| Test | b* | 0.18 | 0.21 | 0.30 | 0.30 |
| piece | Total light ray | 99.9 | 99.8 | 99.8 | 99.7 |
| AS6 | transmittance | | | | |
| | Haze | 0.0 | 0.0 | 0.00 | 0.0 |
| Test | b* | 0.22 | 0.26 | 0.30 | 0.22 |
| piece | Total light ray | 99.8 | 99.8 | 99.7 | 99.7 |
| AS7 | transmittance | | | | |
| | Haze | 0.1 | 0.0 | 0.00 | 0.1 |
| | | Immediately after | | | |
| | | polymerization (after 0 hours) | | | |
| Test | b* | 0.20 | 0.18 | 0.16 | 0.22 |
| piece | Total light ray | 99.8 | 99.8 | 99.8 | 99.8 |
| AS8 | transmittance | | | | |
| | Haze | 0.0 | 0.0 | 0.0 | 0.0 |
| Test | b* | 0.19 | 0.16 | 0.18 | 0.22 |
| piece | Total light ray | 99.8 | 99.8 | 99.8 | 99.8 |
| AS9 | transmittance | | | | |
| | Haze | 0.0 | 0.0 | 0.0 | 0.0 |
| Test | b* | 0.20 | 0.18 | 0.16 | 0.14 |
| piece | Total light ray | 99.8 | 99.8 | 99.8 | 99.8 |
| AL3 | transmittance | | | | |
| | Haze | 0.0 | 0.0 | 0.0 | 0.0 |
| Test | b* | 0.19 | 0.16 | 0.18 | 0.14 |
| piece | Total light ray | 99.8 | 99.8 | 99.8 | 99.8 |
| AL4 | transmittance | | | | |
| | Haze | 0.0 | 0.0 | 0.0 | 0.0 |
| Test | b* | 0.17 | 0.17 | 0.18 | 0.14 |
| piece | Total light ray | 99.7 | 99.8 | 99.9 | 99.8 |
| AL5 | transmittance | | | | |
| | Haze | 0.1 | 0.1 | 0.1 | 0.1 |
| Test | b* | 0.18 | 0.16 | 0.17 | 0.16 |
| piece | Total light ray | 99.8 | 99.8 | 99.9 | 99.9 |
| AL6 | transmittance | | | | |
| | Haze | 0.0 | 0.0 | 0.0 | 0.0 |
| Test | b* | 0.20 | 0.23 | 0.25 | 0.22 |
| piece | Total light ray | 99.8 | 99.8 | 99.8 | 99.8 |
| AL7 | transmittance | | | | |
| | Haze | 0.0 | 0.0 | 0.0 | 0.0 |
| | | After 500 hours | | | |
| Test | b* | 0.22 | 0.35 | 0.37 | 0.30 |
| piece | Total light ray | 99.8 | 99.7 | 99.7 | 99.7 |
| AS8 | transmittance | | | | |
| | Haze | 0.0 | 0.1 | 0.1 | 0.0 |
| Test | b* | 0.21 | 0.34 | 0.36 | 0.22 |
| piece | Total light ray | 99.8 | 99.7 | 99.7 | 99.7 |
| AS9 | transmittance | | | | |
| | Haze | 0.0 | 0.1 | 0.1 | 0.1 |
| Test | b* | 0.22 | 0.35 | 0.37 | 0.34 |
| piece | Total light ray | 99.8 | 99.7 | 99.7 | 99.7 |
| AL3 | transmittance | | | | |
| | Haze | 0.0 | 0.1 | 0.1 | 4.0 |
| Test | b* | 0.21 | 0.34 | 0.36 | 0.34 |
| piece | Total light ray | 99.8 | 99.7 | 99.7 | 99.7 |
| AL4 | transmittance | | | | |
| | Haze | 0.0 | 0.1 | 0.1 | 4.0 |
| Test | b* | 0.18 | 0.31 | 0.71 | 0.39 |
| piece | Total light ray | 99.8 | 99.8 | 99.6 | 99.5 |
| AL5 | transmittance | | | | |
| | Haze | 0.1 | 0.1 | 0.1 | 0.3 |
| Test | b* | 0.18 | 0.21 | 0.30 | 0.30 |
| piece | Total light ray | 99.9 | 99.8 | 99.8 | 99.7 |
| AL6 | transmittance | | | | |
| | Haze | 0.0 | 0.0 | 0.00 | 0.0 |
| Test | b* | 0.22 | 0.26 | 0.30 | 0.22 |
| piece | Total light ray | 99.8 | 99.8 | 99.7 | 99.7 |
| AL7 | transmittance | | | | |
| | Haze | 0.1 | 0.0 | 0.0 | 0.1 |
| | | Immediately after | | | |
| | | polymerization (after 0 hours) | | | |
| Test | b* | 0.20 | 0.18 | 0.16 | 0.22 |
| piece | Total light ray | 99.8 | 99.8 | 99.8 | 99.8 |
| AL8 | transmittance | | | | |
| | Haze | 0.0 | 0.0 | 0.0 | 0.0 |
| Test | b* | 0.19 | 0.16 | 0.18 | 0.22 |
| piece | Total light ray | 99.8 | 99.8 | 99.8 | 99.8 |
| AL9 | transmittance | | | | |
| | Haze | 0.0 | 0.0 | 0.0 | 0.0 |
| Test | b* | 0.22 | 0.22 | 0.22 | 0.22 |
| piece | Total light ray | 99.8 | 99.8 | 99.8 | 99.8 |
| BS1 | transmittance | | | | |
| | Haze | 0.2 | 0.2 | 0.2 | 0.0 |
| Test | b* | 0.19 | 0.19 | 0.19 | 0.19 |
| piece | Total light ray | 99.8 | 99.8 | 99.8 | 99.8 |
| BS2 | transmittance | | | | |
| | Haze | 0.1 | 0.1 | 0.1 | 0.0 |
| Test | b* | 0.22 | 0.22 | 0.22 | 0.22 |
| piece | Total light ray | 99.8 | 99.8 | 99.8 | 99.8 |
| BL1 | transmittance | | | | |
| | Haze | 0.2 | 0.2 | 0.2 | 0.0 |
| Test | b* | 0.19 | 0.19 | 0.19 | 0.19 |
| piece | Total light ray | 99.8 | 99.8 | 99.8 | 99.8 |
| BL2 | transmittance | | | | |
| | Haze | 0.1 | 0.1 | 0.1 | 0.0 |
| | | After 500 hours | | | |
| Test | b* | 0.22 | 0.35 | 0.37 | 0.30 |
| piece | Total light ray | 99.8 | 99.7 | 99.7 | 99.7 |
| AL8 | transmittance | | | | |
| | Haze | 0.0 | 0.1 | 0.1 | 0.0 |
| Test | b* | 0.21 | 0.34 | 0.36 | 0.22 |
| piece | Total light ray | 99.8 | 99.7 | 99.7 | 99.7 |
| AL9 | transmittance | | | | |
| | Haze | 0.0 | 0.1 | 0.1 | 0.1 |
| Test | b* | 0.23 | 0.27 | 0.60 | 0.34 |
| piece | Total light ray | 99.8 | 99.8 | 99.8 | 99.7 |
| BS1 | transmittance | | | | |
| | Haze | 0.0 | 0.0 | 0.1 | 4.0 |
| Test | b* | 0.32 | 0.40 | 0.90 | 0.35 |
| piece | Total light ray | 99.8 | 99.8 | 99.8 | 99.7 |
| BS2 | transmittance | | | | |
| | Haze | 0.1 | 0.1 | 0.1 | 0.1 |
| Test | b* | 0.23 | 0.27 | 0.60 | 0.34 |
| piece | Total light ray | 99.8 | 99.8 | 99.8 | 99.7 |
| BL1 | transmittance | | | | |
| | Haze | 0.0 | 0.0 | 0.1 | 4.0 |
| Test | b* | 0.32 | 0.40 | 0.90 | 0.35 |
| piece | Total light ray | 99.8 | 99.8 | 99.8 | 99.7 |
| BL2 | transmittance | | | | |
| | Haze | 0.1 | 0.1 | 0.1 | 0.1 |

It was found from Table 2 and Table 3 that a polymerization product obtained by polymerizing a polymerizable composition in Embodiment (I) of the present invention was such that it was difficult to cause a change of an appearance such as discoloration and it was possible to maintain a good light transmitting property, even in a case of storage at a high temperature condition for a long period of time.

Furthermore, it was found that a polymerizable composition in Embodiment (II) of the present invention was such that a rate of volume shrinkage at a time of polymerization was low and a polymerization product obtained by polymerizing a polymerizable composition in Embodiment (II) of the present invention was such that it was difficult to cause a change of an appearance such as discoloration and it was possible to maintain a good light transmitting property, even in a case of storage at a high temperature condition for a long period of time.

As described above, a polymerization product film obtained by polymerizing a polymerizable composition in Embodiment (I) of the present invention is such that it is difficult to cause a change of an appearance such as discoloration and it is possible to maintain a good light transmitting property, even in a case of storage at a high temperature condition for a long period of time. Furthermore, a polymerizable composition in Embodiment (II) of the present invention is such that a rate of volume shrinkage at a time of polymerization thereof is low, and a polymerization product layer obtained by polymerizing a polymerizable composition in Embodiment (II) of the present invention is such that it is difficult to cause a change of an appearance such as discoloration and it is possible to maintain a good light transmitting property, even in a case of storage at a high temperature condition for a long period of time. Hence, in a case such a polymerization product film is used as a transparent optical resin layer to be interposed between an image display part of an image display device and a light-transmitting protection part, it is possible to provide a good optical adhesive layer.

Therefore, it is useful to use such a polymerization product for an image display device.

### APPENDIX

(A Polymerizable Composition, a Polymerization Product, an Adhesive Sheet for Optics, an Image Display Device, and a Manufacturing Method Thereof)

An embodiment of the present invention relates to a polymerizable composition that is used for an image display device such as a liquid crystal display device that is used in, for example, a smartphone, a tablet PC, or the like, a polymerization product that is obtained by polymerizing the composition, a manufacturing method of an image display device that uses the composition, and an image display device that is manufactured by the manufacturing method.

A embodiment of the present invention aims at providing a polymerizable composition for manufacturing a polymerization product with a small rate of volume shrinkage at a time of polymerization thereof, a low dielectric constant, and a less heat-caused discoloration, a polymerization product that is obtained by polymerizing the composition (and includes an adhesive sheet for optics), an image display device that uses the polymerization product, and a manufacturing method of the image display device, in order to solve the problem(s) described above.

The inventor(s) of an embodiment(s) of the present invention actively studied in order to solve the problem(s) described above, and as a result, found that a polymerizable composition that includes a compound that has a particular structure and contains a(n) (meth)acryloly group is such that a rate of volume shrinkage at a time of polymerization is small, a polymerization product obtained by polymerization is of a low dielectric constant, and a heat-caused discoloration thereof is small, and completed or achieved an embodiment(s) of the present invention.

Namely, Embodiment (I) of the present invention relates to a polymerizable composition for manufacturing a polymerization product that forms a polymerization product layer to be interposed between an image display part of an image display device and a light-transmitting protection part, wherein the polymerizable composition is characterized in that the polymerizable composition includes Component 1 described below, Component 2 described below, and Component 3 described below as essential components.

Component 1: a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid,

Component 2: a compound that contains a hydrocarbon group with a carbon number more than or equal to 6 and a(n) (meth)acryloyl group, and

Component 3: a photopolymerization initiator.

Embodiment (II) of the present invention relates to a polymerizable composition for manufacturing a polymerization product that forms a polymerization product layer to be interposed between an image display part of an image display device and a light-transmitting protection part, wherein the polymerizable composition is characterized in that the polymerizable composition includes Component 1 described below, Component 2 described below, Component 3 described below, and Component 4 described below as essential components.

Component 1: a(n) (meth)acrylate compound that is produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid,

Component 2: a compound that contains a hydrocarbon group with a carbon number more than or equal to 6 and a(n) (meth)acryloyl group,

Component 3: a photopolymerization initiator, and

Component 4: a compound with no (meth)acryloyl group in a molecule thereof that does not have any one of a function of suppressing a radical polymerization, a function of inhibiting a radical polymerization, and a photopolymerization initiation function and is composed of a carbon atom(s) and a hydrogen atom(s) or composed of a carbon atom(s), a hydrogen atom(s), and an oxygen atom(s).

Embodiment (III) of the present invention relates to a polymerization product that is obtained by polymerizing the polymerizable composition described in Embodiment (I) of the present invention or Embodiment (II) of the present invention.

Embodiment (IV) of the present invention relates to a polymerizable composition for manufacturing an adhesive sheet for optics that is used as a polymerization product layer to be interposed between an image display part of an image display device and a light-transmitting protection part, wherein the polymerizable composition is characterized in that the polymerizable composition is the polymerizable composition of Embodiment (I) of the present invention or Embodiment (II) of the present invention.

Embodiment (V) of the present invention relates to an adhesive sheet for optics that has a polymerization product layer with a thickness of 10-500 μm that is obtained by applying the polymerizable composition of Embodiment (IV) of the present invention and irradiating the composition with light to which a photopolymerization initiator is sensitive, to cause a polymerization thereof.

Embodiment (VI) of the present invention relates to a manufacturing method of an image display device that has a step of interposing and polymerizing a polymerizable composition between a base part having an image display part and a light-transmitting protection part to form a polymerization product layer, wherein the manufacturing method of an image display device has a step of interposing the polymerizable composition of Embodiment (II) of the present invention and irradiating the composition with light to which a photopolymerization initiator is sensitive.

Embodiment (VII) of the present invention relates to a manufacturing method of an image display device that has a step of bonding a base part having an image display part and a light-transmitting protection part by using an adhesive sheet for optics, the manufacturing method of an image display device is characterized in that the adhesive sheet for optics is the adhesive sheet for optics of Embodiment (V) of the present invention.

Embodiment (VIII) of the present invention relates to an image display device manufactured by the manufacturing method of an image display device of Embodiment (VI) of the present invention or Embodiment (VII) of the present invention.

Moreover, embodiments of the present invention relate to the following [1]-[16].

[1]: A polymerizable composition for forming a polymerization product layer to be interposed between an image display part of an image display device and a light-transmitting protection part, the polymerizable composition is characterized in that the polymerizable composition includes:

(component 1): a(n) (meth)acrylate compound produced by an ester exchange reaction between a hydrogenated polyolefin polyol and a(n) (meth)acrylic acid ester and/or a dehydration condensation reaction between a hydrogenated polyolefin polyol and a(n) (meth)acrylic acid;

(component 2): a compound that contains a hydrocarbon group with a carbon number more than or equal to 6 and a(n) (meth)acryloyl group; and

(component 3): a photopolymerization initiator.

[2]: The polymerizable composition as described in [1] characterized by further including:

(component 4): a compound with no (meth)acryloyl group in a molecule thereof that does not have any one of a function of suppressing a radical polymerization, a function of inhibiting a radical polymerization, and a photopolymerization initiation function, and is composed of a carbon atoms) and a hydrogen atom(s) or composed of a carbon atom(s), a hydrogen atom(s), and an oxygen atom(s).

[3]: The polymerizable composition as described in [2] characterized in that the compound of component 4 is at least one kind selected from a compound that is liquid at 25° C. and a compound that is solid at 25° C.

[4]: The polymerizable composition as described in [3] wherein the compound that is liquid at 25° C. is at least one kind selected from a group composed of a poly(α-olefin) liquid substance, an ethylene-propylene copolymerization liquid substance, a propylene-α-olefin copolymerization liquid substance, an ethylene-α-olefin copolymerization liquid substance, a liquid polybutene, a liquid hydrogenated polybutene, a liquid polybutadiene, a liquid hydrogenated polybutadiene, a liquid polyisoprene, a liquid hydrogenated polyisoprene, a liquid polybutadiene polyol, a liquid hydrogenated polybutadiene polyol, a liquid polyisoprene polyol, a liquid hydrogenated polyisoprene polyol, and a hydrogenated dimer diol.

[5]: The polymerizable composition as described in [3] wherein the compound that is liquid at 25° C. is a compound that has 1 or less carbon-carbon unsaturated bond in a molecule thereof.

[6]: The polymerizable composition as described in [5] wherein the compound that is liquid at 25° C. is at least one kind selected from a group composed of a liquid poly(α-olefin) liquid substance, an ethylene-propylene copolymerization liquid substance, an ethylene-α-olefin copolymerization liquid substance, a propylene-α-olefin copolymerization liquid substance, a liquid polybutene, a liquid hydrogenated polybutene, a liquid hydrogenated polybutadiene, a liquid hydrogenated polyisoprene, a liquid hydrogenated polybutadiene polyol, a liquid hydrogenated polyisoprene polyol, and a hydrogenated dimer diol.

[7]: The polymerizable composition as described in any one of [3]-[6] wherein the compound that is solid at 25° C. is at least one kind selected from a group composed of a hydrogenated petroleum resin, a terpene-type hydrogenated resin, and a hydrogenated rosin ester.

[8]: The polymerizable composition as described in any one of [1]-[7] characterized by further including:

(compound 5): a compound that has an alcoholic hydroxyl group and contains a(n) (meth)acryloyl group.

[9]: The polymerizable composition as described in any one of [1]-[8] characterized in that the hydrogenated polyolefin polyol is a hydrogenated polybutadiene polyol and/or a hydrogenated polyisoprene polyol.

[10]: A polymerization product that is obtained by polymerizing the polymerizable composition as described in any one of [1]-[9].

[11]: A polymerizable composition for manufacturing an adhesive sheet for optics with a polymerization product layer formed thereon, the polymerizable composition is characterized in that the polymerizable composition is the polymerizable composition as described in any one of [1]-[8].

[12]: An adhesive sheet for optics that has a polymerization product layer with a thickness of 10-500 μm that is obtained by applying the polymerizable composition of [11] and irradiating the composition with light to which a photopolymerization initiator is sensitive, to cause polymerization thereof.

[13]: A manufacturing method of an image display device that has a step of interposing and polymerizing a polymerizable composition between a base part having an image display part and a light-transmitting protection part to form a polymerization product layer, wherein the manufacturing method of an image display device has a step of interposing the polymerizable composition as described in any one of [2]-[9] and irradiating the composition with light to which a photopolymerization initiator is sensitive.

[14]: A manufacturing method of an image display device that has a step of bonding a polymerization product layer between a base part having an image display part and a light-transmitting protection part by using an adhesive sheet for optics, the manufacturing method of an image display device is characterized in that the adhesive sheet for optics is the adhesive sheet for optics as described in [12].

[15]: An image display device manufactured by the method as described in [13] or [14].

[16]: The image display device as described in [15] characterized in that the image display part is a liquid crystal display panel.

Here, a “polymerization product” described in the present specification is not particularly limited with respect to a shape or the like as long as such a polymerization product is obtained by polymerizing a polymerizable composition, and means that an “adhesive sheet for optics” described in the specification is also included in such a polymerization product.

Furthermore, a “polymerization product layer interposed between an image display part and a light-transmitting protection part” described in the present specification means any polymerization product layer between an image display part and a light-transmitting protection part, and for example, means that any of 5a and 5b in FIG. 2 is also included therein.

According to a polymerizable composition of an embodiment of the present invention, a polymerization product does not have a capacitor function even in a case where a polymerization product (that includes an adhesive sheet for optics) in FIG. 2-FIG. 5 is thinner than a conventional one, because it is possible to provide a polymerization product with a low dielectric constant, and as a result, it is possible to prevent an electrical malfunction much better than a conventional one. That is, it is possible to cause an image display device such as a liquid crystal panel to be a thin layer.

Moreover, according to a polymerizable composition of an embodiment of the present invention, it is possible to suppress a stress caused by a volume shrinkage as being a minimum when it is applied and polymerized between an image display part and a protection part, so that it is also possible to suppress an influence of this stress on an image display part and a protection part as being a minimum when an image display device is manufactured by using a step of interposing and polymerizing a polymerizable composition between a base part having an image display part and a light-transmitting protection part to form a polymerization product layer. Therefore, according to an image display device of an embodiment of the present invention, a little deformation is caused on an image display part and a protection part.

Furthermore, a polymerization product or an adhesive sheet for optics according to an embodiment of the present invention is such that its refractive index is closer to a refractive index of a panel component of an image display part or a panel component of a protection part than that of an air gap that is conventionally provided between a liquid crystal display panel and a protection part, and reflection of light from an interface between a protection part and a polymerization product, an interface between a polymerization product and an image display part, an interface between a protection part and an optical adhesive sheet, or an interface between an optical adhesive sheet and an image display part is suppressed. As a result, according to an image display device of an embodiment of the present invention, it is possible to provide a display with high brightness and high contrast without a defective display.

Moreover, in a case where an image display part is a liquid crystal display panel, it is possible to absolutely prevent a defective display caused by a disturbance in an orientation of a liquid crystal material or the like and provide a display at a high quality.

Moreover, an image display device of an embodiment of the present invention resists impact thereon because a polymerization product or an optical adhesive sheet is interposed between an image display part and a protection part.

Moreover, it is possible for a polymerization product or an optical adhesive sheet of an embodiment of the present invention to maintain a display at high brightness and high contrast for a long period of time because such a polymerization product or an optical adhesive sheet is not readily colored even in a case where such a polymerization product or an optical adhesive sheet has been subjected to heat history.

In addition, according to an embodiment of the present invention, it is possible to provide an image display device that is thinner than a conventional example wherein an air gap is provided between an image display part and a protection part.

Although the illustrative embodiment(s) and specific example(s) of the present invention have been described with reference to the accompanying drawing(s), the present invention is not limited to any of the illustrative embodiment(s) and specific example(s), and the illustrative embodiment(s) and specific example(s) may be altered, modified, or combined without departing from the scope of the present invention.

The present application claims the benefit of priority based on Japanese Patent Application No. 2012-074249 filed on Mar. 28, 2012 in Japan, and the entire contents thereof are hereby incorporated by reference herein.

### EXPLANATION OF LETTERS OR NUMERALS

1 . . . display device
2 . . . display part
3 . . . protection part (or a touch-sensor-integrating protection part in FIG. 4 or FIG. 5)
4 . . . spacer
5a, 5b . . . polymerization product (layer)
6a, 6b . . . light polarizing plate

1. A polymerizable composition, comprising:
a first component selected from the group consisting of compounds produced by an ester exchange reaction between a hydrogenated polyolefin polyol and an acrylic acid ester, compounds produced by an ester exchange reaction between a hydrogenated polyolefin polyol and a methacrylic acid ester, compounds produced by a dehydration condensation reaction between a hydrogenated polyolefin polyol and an acrylic acid, and compounds produced by a dehydration condensation reaction between a hydrogenated polyolefin polyol and a methacrylic acid;
a second component selected from the group consisting of compounds containing a hydrocarbon group with a carbon number more than or equal to 6 and an acryloyl group and compounds containing a hydrocarbon group with a carbon number more than or equal to 6 and a methacryloyl group; and
a third component selected from the group consisting of photopolymerization initiators.

2. The polymerizable composition as claimed in claim 1, further comprising:
a fourth component selected from the group consisting of compounds having none of an acryloyl group, a methacryloyl group, a function of suppressing a radical polymerization, a function of inhibiting a radical polymerization, and a photopolymerization initiation function and composed of a carbon atom(s) and a hydrogen atom(s), and compounds having none of an acryloyl group, a methacryloyl group, a function of suppressing a radical polymerization, a function of inhibiting a radical polymerization, and a photopolymerization initiation function and composed of a carbon atom(s), a hydrogen atom(s), and an oxygen atom(s).

3. The polymerizable composition as claimed in claim 2, wherein the fourth component includes a substance selected from the group consisting of compounds being a liquid at 25° C. and compounds being a solid at 25° C.

4. The polymerizale composition as claimed in claim 2, wherein the fourth component includes a compound being a liquid at 25° C., and the compound being a liquid at 25° C. includes a substance selected from the group consisting of poly(α-olefin) liquid substances, ethylene-propylene copolymerization liquid substances, ethylene-α-olefin copolymerization liquid substances, propylene-α-olefin copolymerization liquid substances, liquid polybutenes, liquid hydrogenated polybutenes, liquid polybutadienes, liquid hydrogenated polybutadienes, liquid polyisoprenes, liquid hydrogenated polyisoprenes, liquid polybutadiene polyols, liquid hydrogenated polybutadiene polyols, liquid polyisoprene polyols, liquid hydrogenated polyisoprene polyols, and hydrogenated dimer diols.

5. The polymerizable composition as claimed in claim 2, wherein the fourth component includes a compound being liquid at 25° C., and the compound being liquid at 25° C. includes a substance selected from the group consisting of compounds having one carbon-carbon unsaturated bond and compounds having no carbon-carbon unsaturated bond.

6. The polymerizable composition as claimed in claim 5, wherein the substance includes a substance selected from the group consisting of liquid poly(α-olefin) liquid substances, ethylene-propylene copolymerization liquid substances, ethylene-α-olefin copolymerization liquid substances, propylene-α-olefin copolymerization liquid substances, liquid polybutenes, liquid hydrogenated polybutenes, liquid hydrogenated polybutadienes, liquid hydrogenated polyisoprenes, liquid hydrogenated polybutadiene polyols, liquid hydrogenated polyisoprene polyols, and hydrogenated dimer diols.

7. The polymerizable composition as claimed in claim 2, wherein the fourth component includes a compound being a solid at 25° C., and the compound being a solid at 25° C. includes a substance selected from the group consisting of hydrogenated petroleum resins, terpene-type hydrogenated resins, and hydrogenated rosin esters.

8. The polymerizable composition as claimed in claim 1, further comprising:
a fifth component selected from the group consisting of compounds containing an acryloyl group and having an alcoholic hydroxyl group and compounds containing a methacryloly group and having an alcoholic hydroxyl group.

9. The polymerizable composition as claimed in claim 1, wherein the hydrogenated polyolefin polyol includes a substance selected from the group consisting of hydrogenated polybutadiene polyols and hydrogenated polyisoprene polyols.

10. A polymerization product obtainable by photopolymerizing the polymerizable composition as claimed in claim 1.

11. An adhesive sheet, comprising:
the polymerization product as claimed in claim 10; and
a layer having a thickness greater than or equal to 10 μm and less than or equal to 500 μm.

12. A method for manufacturing an image display device, comprising:
a step of interposing the polymerizable composition as claimed in claim 2 between a base part having an image display part and a light-transmitting protection part; and
a step of photopolymerizing the polymerizable composition to form a polymerization product layer between the base part and the protection part.

13. A method for manufacturing an image display device, comprising:
a step of bonding a base part having an image display part and a light-transmitting protection part by using the adhesive sheet as claimed in claim 11.

14. The method for manufacturing an image display device as claimed in claim 12, wherein the image display part includes a liquid crystal display panel.

15. The method for manufacturing an image display device as claimed in claim 13, wherein the image display part includes a liquid crystal display panel.

16. An image display device capable of being manufactured by the method for manufacturing an image display device as claimed in claim 12.

17. An image display device capable of being manufactured by the method for manufacturing an image display device as claimed in claim 13.
